(19) United States
(12) Patent Application Publication
(10) Pub. No.: US 2025/0156692 A1
(43) Pub. Date: May 15, 2025

(54) CONDITIONAL GENERATIVE MODEL FOR GENERATING INORGANIC MATERIAL CANDIDATES

(71) Applicant: Microsoft Technology Licensing, LLC, Redmond, WA (US)

(72) Inventors: Tian XIE, Cambridge (GB); Andrew Thomas FOWLER, Bishops Stortford (GB); Claudio ZENI, Cambridge (GB); Daniel ZUEGNER, Berlin (DE); Robert PINSLER, Cambridge (GB); Ryota TOMIOKA, Cambridge (GB); Matthew Kristofer HORTON, Seattle, WA (US); Xiang FU, Cambridge, MA (US)

(73) Assignee: Microsoft Technology Licensing, LLC, Redmond, WA (US)

(21) Appl. No.: 18/759,208

(22) Filed: Jun. 28, 2024

Related U.S. Application Data
(60) Provisional application No. 63/598,890, filed on Nov. 14, 2023.

(51) Int. Cl. G06N 3/0475; G06N 3/096

(52) U.S. Cl. CPC G06N 3/0475; G06N 3/096

(57) ABSTRACT

Examples are disclosed that relate to a generative model for generating inorganic material candidates, such as crystalline structures. One example provides a method, comprising training an unconditional generative model using a dataset of stable periodic material structures, the unconditional generative model comprising a diffusion model. The training comprises learning the diffusion model to iteratively noise the stable periodic material structures of the dataset towards a random periodic structure by noising atom types of atoms in the periodic material structure, noising fractional coordinates of the atoms in the periodic material structure, and noising a lattice of the periodic material structure. The method further comprises using the trained unconditional generative model to generate a material structure by iteratively denoising an initial structure sampled from a random distribution.

### CROSS REFERENCE TO RELATED APPLICATIONS

This application claims priority to U.S. Provisional Patent Application Ser. No. 63/598,890, filed Nov. 14, 2023, the entirety of which is hereby incorporated herein by reference for all purposes.

### BACKGROUND

In materials science, inverse design refers to the process of directly generating material structures given a set of desired properties and characteristics. Significant technical challenges exist to the development of such inverse design tools, and solving these challenges is a goal of ongoing research. Recently, technical progress has been made in the field of molecular inverse design. However, in the field of crystalline materials, inverse design is still at its infancy.

### SUMMARY

Examples are disclosed that relate to a generative model for generating inorganic material candidates, such as crystalline structures. The model is referred to as MatterGen throughout. One example provides a method, comprising training an unconditional generative model using a dataset of stable periodic material structures, the unconditional generative model comprising a diffusion model. The training comprises learning the diffusion model to iteratively noise the stable periodic material structures of the dataset towards a random periodic structure by noising atom types of atoms in the periodic material structure, noising fractional coordinates of the atoms in the periodic material structure, and noising a lattice of the periodic material structure. The method further comprises using the trained unconditional generative model to generate a material structure by iteratively denoising an initial structure sampled from a random distribution.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A-1B show a schematic view illustrating inorganic material design with a generative model according to one example of the present disclosure, referred to as MatterGen.

FIGS. 2A-2I includes several visualizations and charts that illustrate generating stable, diverse inorganic materials using the generative model of FIG. 1A.

FIGS. 3A-3I show various charts illustrating the conditional generation of materials in a target chemical system, using the generative model of FIG. 1A.

FIGS. 4A-4H show a chart and various visualizations illustrating the conditional generation of materials with target symmetry using the generative model of FIG. 1A.

FIGS. 5A-5O shows various charts and visualizations illustrating the conditional generation of materials with target magnetic, electronic, and mechanical properties, using the generative model of FIG. 1A.

FIGS. 6A-6F shows various charts and visualizations illustrating the design of low supply chain risk magnets using the generative model of FIG. 1A.

FIG. 7 shows a flow diagram of an example method for generating materials structures using a generative model comprising a diffusion model.

FIG. 8 shows a table which includes summary information on 46 on-hull crystal structures produced by unconditional generation using the generative model of FIG. 1A.

FIG. 9 shows the distribution of elements in a Materials Project dataset (MP) and a combined Materials Project-Alexandria dataset (Alex-MP), used to train the generative model of FIG. 1.

FIG. 10 shows a table with categorization of 27 chemical systems used to benchmark model capabilities on chemical system exploration by the generative model of FIG. 1A.

FIG. 11 shows a table listing a summary of general and diffusion notations used herein.

FIG. 12 shows a diagram illustrating two equivalent lattice choices with different lattice vectors 11, 12 that lead to the same periodic structure, which may be generated by the generative model of FIG. 1A.

FIG. 13 shows a schematic view of an example computing environment that may be used to implement the generative model of FIG. 1A.

### DETAILED DESCRIPTION

The present disclosure presents MatterGen, a generative model that generates stable inorganic materials across the periodic table and can be conditioned to steer the generation towards desired property, chemistry, and symmetry conditions. To enable this, the present disclosure introduces a diffusion process that respects the periodicity and density statistics of materials, a large, energy-compatible training dataset of stable materials, and a fine-tuning scheme to steer the generation towards desired conditions with only a small property-labeled dataset. MatterGen generates significantly more stable, close-to-equilibrium structures than previous models. It demonstrates the capability to generate stable materials with desired property, chemistry, and symmetry conditions with high success rates. The present disclosure showcases its capability by designing low-supply-chain risk magnets as an example of optimizing multiple properties for a realistic materials design problem.

### 1. Main

Many technological and societal challenges depend on the ability to design functional materials with desired properties and characteristics. With the advance of high throughput screening, open material databases, machine learning based property predictors, and machine learning force fields (MLFFs), it becomes increasingly routine to screen hundreds of thousands of materials to identify candidates for a broad range of applications, such as superionic conductors for lithium ion batteries and many others. However, screening-based methods are fundamentally limited by the size of known stable materials. The largest explorations of previously unknown materials are in the orders of 10⁶-10⁷, which is only a tiny fraction of the number of potential stable inorganic compounds (˜10¹⁰ quaternary compounds without considering structures). Further, screening cannot explore unknown materials guided by desired properties, limiting its efficiency in finding candidates for rare or even conflicting properties.

To overcome these limitations, many consider the ability to “inversely design” materials as the holy grail of materials science. It enables the direct generation of novel materials guided by target properties, potentially solving challenging materials design problems that require finding materials with rare or even conflicting properties. Despite recent progress, contemporary methods often fall short of generating stable materials according to quantum mechanical calculations or are limited to a relatively narrow space of elements. They are also limited to generating materials given simple properties like formation energy or band gaps, etc.

The present disclosure describes an example generative model that generates stable, novel, diverse inorganic materials across the periodic table and can be conditioned to steer the generation towards various conditions including properties, chemical systems, and symmetry. The base model is an unconditional generative model comprising a diffusion model that generates inorganic materials using an iterative denoising process. The disclosed example generative model more than doubles the percentage of stable, novel, unique materials. Further, the example model can generate structures that are closer to equilibrium structures than other methods. The unconditional generative model can be fine-tuned to form a conditional generative model. By steering the generation towards various conditions, the example conditional generative models generate more stable or comparably stable materials in target chemical systems than other search methods (such as state-of-the-art substitution and random structure search methods). Additionally, the disclosed conditional generative models are capable of generating highly symmetric structures given conditions related to a desired space group, and can directly generate materials given conditions related to selected mechanical, electronic, and/or magnetic properties. Finally, the disclosed example generative models are capable of generating materials given multiple conditions. In one particular example, the present disclosure showcases this capability by describing the design of a material with high magnetic density yet composed of elements with low supply chain risk.

### 2 Results

### 2.1 MatterGen Framework

As mentioned above, the example generative model is referred to as “MatterGen” throughout. The MatterGen framework is a diffusion model that generates the atom types, coordinate, and lattice of a material structure from an initial structure sampled from a random distribution via an iterative denoising process. MatterGen generates stable, diverse materials across the periodic table while sampled unconditionally. With a small dataset of material structures and corresponding condition labels, it can be fine-tuned to form a conditional generative model that can generate materials given the desired conditions. A description of the most important ideas and components is provided below. The generative model architecture and training procedure are discussed in more detail below in Appendices D, E, F, and G.

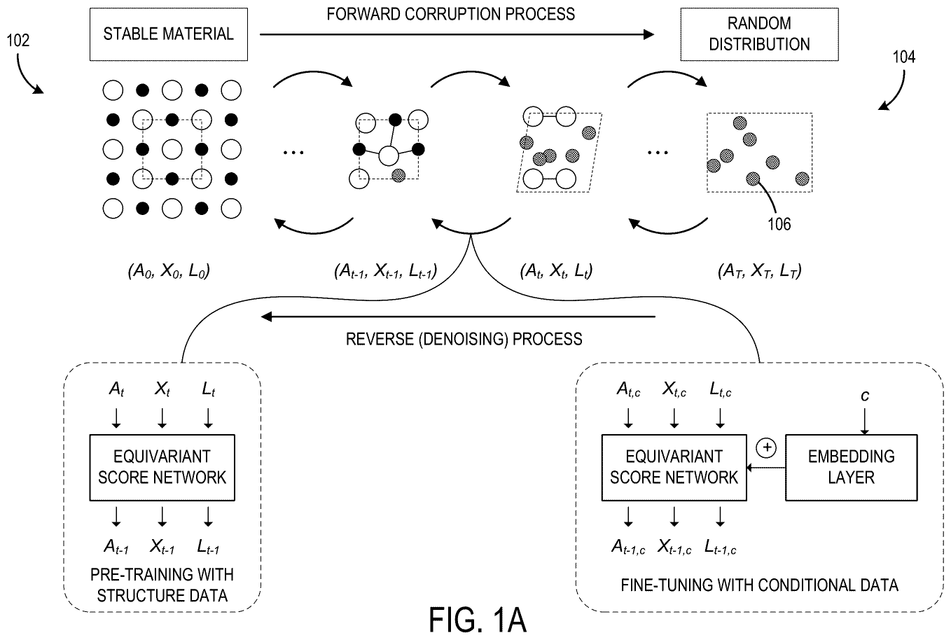

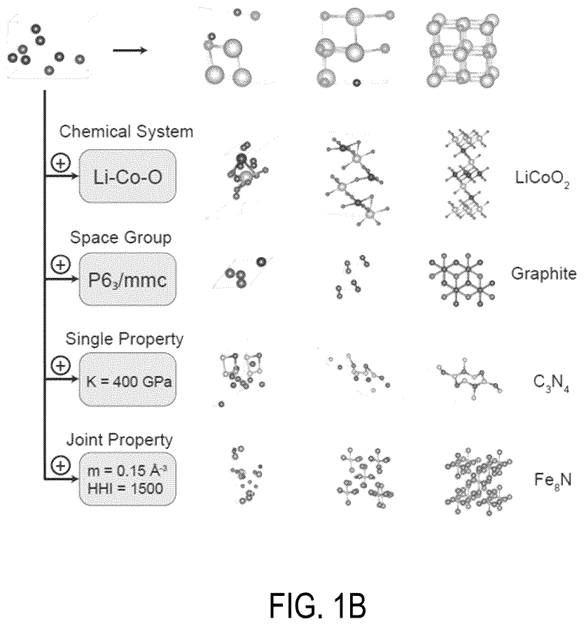

The core of the diffusion model is a corruption (also referred to herein as “noising”) process that iteratively corrupts (noises) a stable periodic structure towards a distribution of random periodic structures with a fixed atomic density. FIG. 1A shows noising of a stable periodic structure 102 to random periodic structures 104. In the forward process, the atom types (A), coordinates (X), and lattice (L) are independently corrupted to generate training data for the denoising score network. The system of the present disclosure corrupts atom types to an absorbing state, shown as grey atoms 106 in FIG. 1. Any suitable noising process can be used. One example uses the D3PM approach. The system of the present disclosure corrupts the fractional coordinates using a wrapped normal distribution to approach a uniform distribution at the noisy limit (inspired by DiffDock, and also used in DiffCSP). For the lattice, symmetric noise can be added to the lattice to approach a limiting cubic lattice with a fixed atomic density (discussed in more detail below at Section D.7). In the reverse process, the score networks learn to jointly denoise atom types, coordinates, and the lattice, to generate stable materials from randomly sampled initial structures.

To generate materials with desired conditions, the present disclosure introduces a scheme to fine-tune the unconditional denoising score network to a conditional score network using an additional labeled dataset. Fine-tuning is chosen instead of training a conditional network from scratch like other approaches such as Stable Diffusion or DALLE-2 because the size of property-labeled dataset is often significantly smaller than structure dataset for mate-rials. The system of the present disclosure encodes the conditions via an embedding layer, and adds such embeddings to each layer of the score network to fine-tune its output scores. After the fine-tuning, classifier-free guidance is used to steer the generation towards any target conditions, including chemical systems, space groups, a single property, and multiple properties.

### 2.2 Generating Stable, Diverse Materials Unconditionally

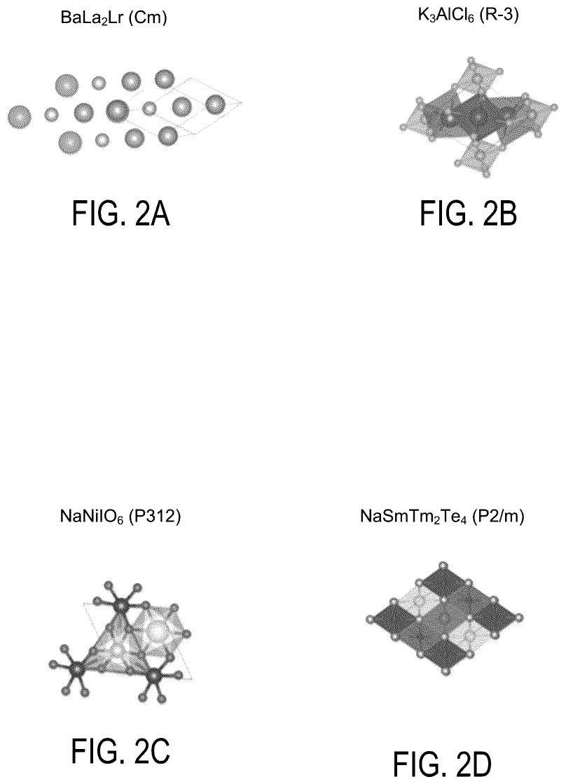

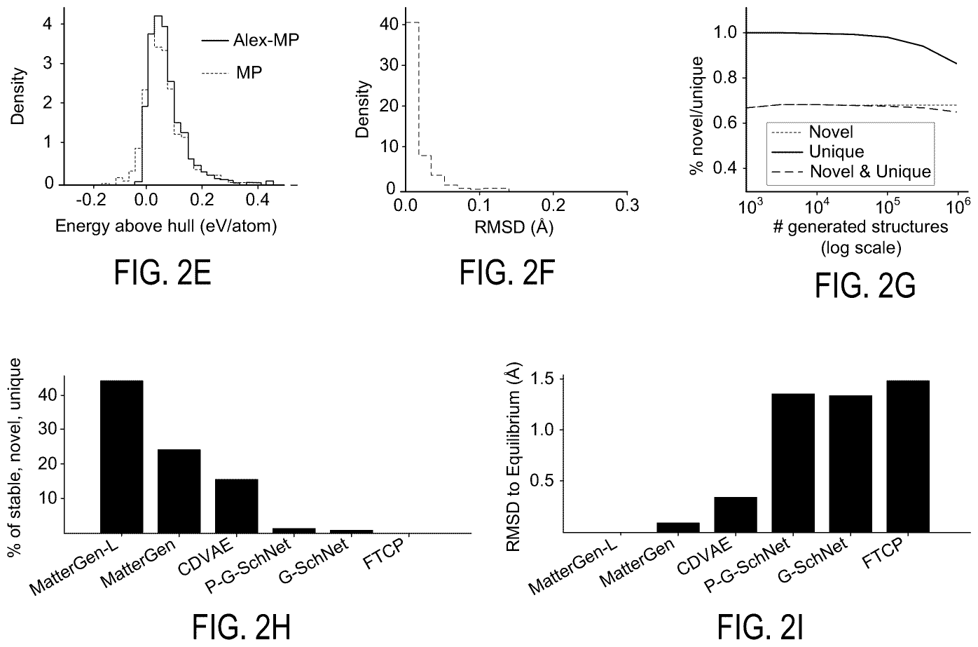

The foundation of MatterGen is an unconditional generative model that can be fine-tuned on a broad range of tasks. To work for many classes of materials, it is configured to generate stable, diverse materials across the periodic table. To train the model of the system of the present disclosure, a large, diverse dataset including 607,684 unique structures recomputed from the Materials Project (MP) and Alexandria (Alex) datasets was used. Details of the MP dataset can be found at Jain, A., Ong, S. P., Hautier, G., Chen, W., Richards, W. D., Dacek, S., Cholia, S., Gunter, D., Skinner, D., Ceder, G., Persson, K. A., “Commentary: The Materials Project: A materials genome approach to accelerating materials innovation.” APL materials 1.1 (2013). Details of the Alex dataset can be found at Schmidt, J., Hoffmann, N., Wang, H. C., Borlido, P., Carriço, P. J., Cerqueira, T. F., Botti, S., Marques, M. A. “Large-scale machine-learning-assisted exploration of the whole materials space.” arXiv preprint arXiv: 2210.00579 (2022); and Schmidt, Jonathan, et al. “A dataset of 175 k stable and metastable materials calculated with the PBEsol and SCAN functionals.” Scientific Data 9.1 (2022): 64. MatterGen was trained using the MP dataset. A variant, MatterGen-L, was trained using the combined Alex-MP dataset. In FIGS. 2A-2D, a few randomly selected generated samples are shown with chemical formula and space group. After training MatterGen with the dataset, the trained model generates novel crystals with symmetry and coordination environments, as shown in FIGS. 2A-2D. To further evaluate their stability, density functional theory (DFT) calculations show that 77.8% and 13.0% of generated structures fall below the 0.1 eV/atom and 0.0 eV/atom thresholds of MP's convex hull, while 75.2% and 2.6% fall below the 0.1 eV/atom and 0.0 eV/atom thresholds of the combined Alex-MP hull (FIG. 2E). Further, 95% of generated structures have RMSD (root mean square deviation) to DFT relaxed structure smaller than 0.076 Å, which is one order of magnitude smaller than the atomic radius of the hydrogen atom 0.53 Å (FIG. 2F). These results indicate the majority of structures generated by the present model are stable or meta-stable, and very close to the equilibrium. One of the major promises of generative models is the ability to discover a large number of diverse materials beyond the training data. FIG. 2G shows that the percentage of unique structures only drops from 100% to 86.3% after generating 1 million structures, indicating MatterGen's ability to keep generating diverse structures even after scaling to millions of candidates. The percentage of novel structures with respect to Alex-MP stays almost the same at ˜68%, and it is expected that the percentage of stable materials will stay roughly the same as FIGS. 2E-2F, even though DFT calculations were not run for all the structures to confirm this point. These results indicate that the present model can keep generating stable, diverse, novel structures even after scaling to millions of structures.

MatterGen is compared with previous material generative models and shows a significant improvement as a result of both model innovation and scaling up of the training data. In FIGS. 2H-2I, it is shown that the present model improves the percentage of stable (below 0.1 eV/atom of Alex-MP hull), novel (with respect to Alex-MP), and unique structures from 15.8% to 27.9% compared with previous state-of-the-art CDVAE, and reduces the RMSD from 0.360 Å to 0.115 Å compared to the previous state-of-the-art generative model. The improved performance is believed to come from the newly introduced lattice diffusion (Section D.7), and the innovations introduced in both coordinate (Section D.6) and atom type diffusion (Section D.5). By scaling up the training data from 27 k to 608 k, a variant of the model, MatterGen-L, further improves the percentage of stable, novel, unique structures to 43.2%, and reduces the average RMSD to 0.021 Å.

After demonstrating the capability to generate stable, diverse inorganic materials unconditionally, the present disclosure next explores the capability of MatterGen to perform various materials design tasks by conditioning on different constraints.

### 2.3 Generating Materials in Target Chemical System

Finding the most stable material structure in a target chemical system is one of the major challenges in materials design. The most reliable approach for this task is ab-initio random structure search (RSS), which has been shown to discover many novel materials that were later experimentally synthesized. Unfortunately, it is very expensive and requires half a million DFT calculations to thoroughly explore a ternary system. In recent years, the combination of random or substitution-guided generation with MLFFs has proven successful in thoroughly exploring chemical systems with binary, ternary, sometimes quaternary systems. Despite these advances, the reliable exploration of systems with 5 and more elements remains challenging, and more computationally-efficient ways to reliably propose novel structures close to the hull are required.

Here, the present MatterGen is fine-tuned to form a conditional generative model that can be used to generate materials given a target chemical system and investigate its performance against the substitution and random structure search (RSS) methods, equipped with a the state-of-the-art MLFFs. To improve performance, the present conditional generative model is fine-tuned on two properties, chemical system and energy above convex hull, via the procedure detailed in Section E.2 below. The benchmark evaluation is performed for 9 ternary, 9 quaternary, and 9 quinary chemical systems. For each of these three groups, 3 chemical systems are picked at random from the following categories: well explored, partially explored, and not explored (see Section F.2 below for additional details).

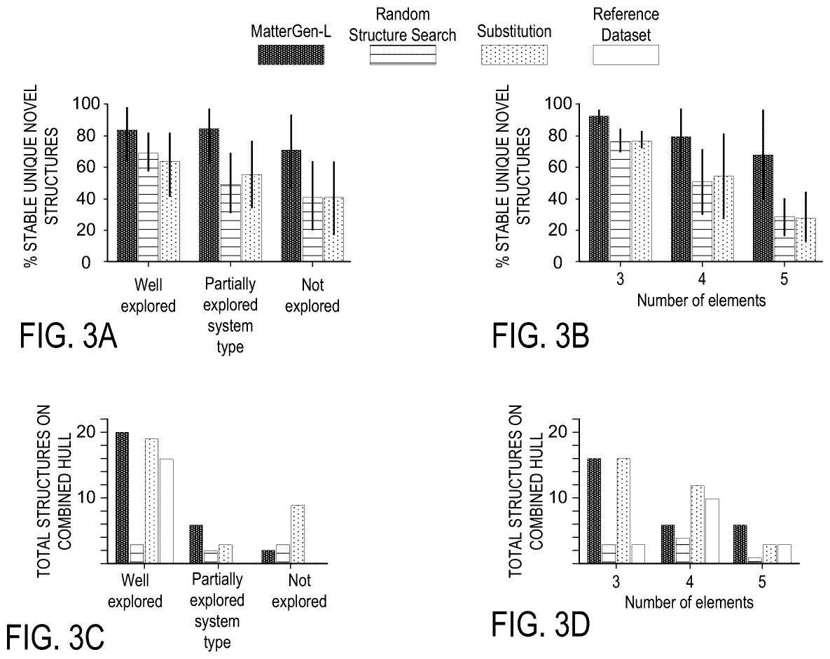

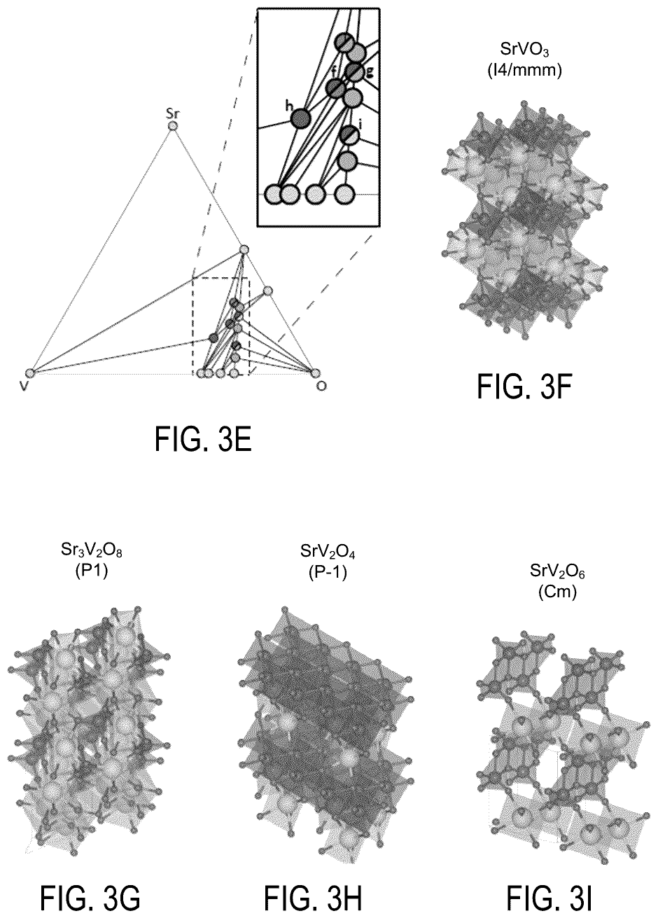

FIGS. 3A-3I showcase the performance of conditional generation using MatterGen-L and the benchmarks. As shown in FIGS. 3A-3B, MatterGen-L generates the highest percentage of stable, unique, and novel (SUN) structures for every system type and every chemical complexity. FIG. 3C highlights how the conditional generative model finds the highest number of unique structures on the combined convex hull in ‘partially explored’ systems, where existing structures on hull were provided during training, and in “well-explored systems”, where structures on the hull are known but were not provided in training. Moreover, while substitution offers a comparable or more efficient way to generate structures on the hull for ternary and quaternary systems, the present method achieves better performance on quinary systems, as shown in FIG. 3D. Such performance improvement is even more apparent if the number of structures generated is considered and relaxed with a MLFF for each method in quinary systems: 10,240 for the present model, ˜70,000 for substitution, and ˜600,000 for RSS (see Section F.2 below for additional details). FIG. 3E showcases the combined convex hull for V—Sr—O, a non-cherry-picked example of a ternary well-explored compound, and highlights the structures discovered by each method. In FIGS. 3F, 3G, 3H, and 3I, the structures discovered by MatterGen-L that expand the known convex hull for the system shown in FIG. 3E, are displayed.

2.4 Designing Materials with Target Symmetry

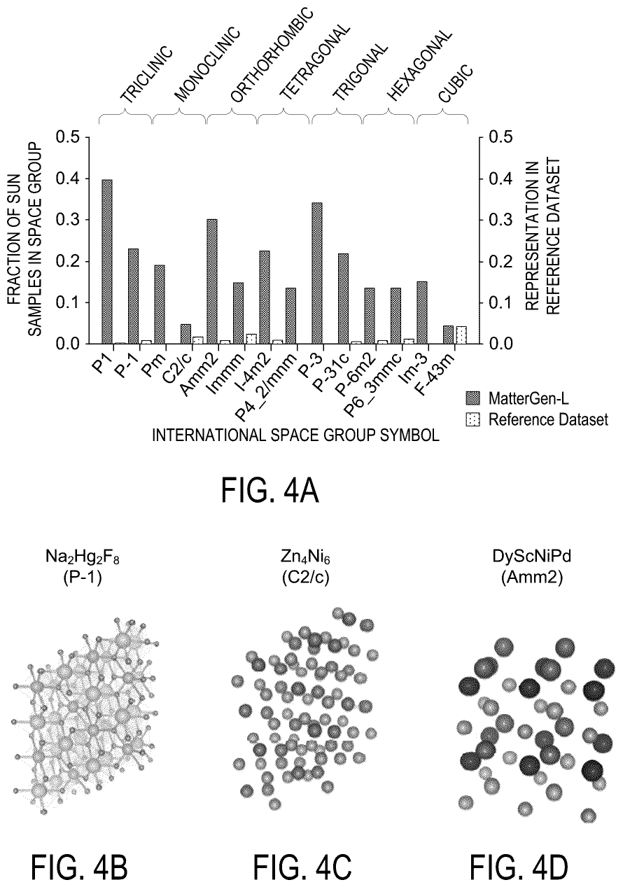

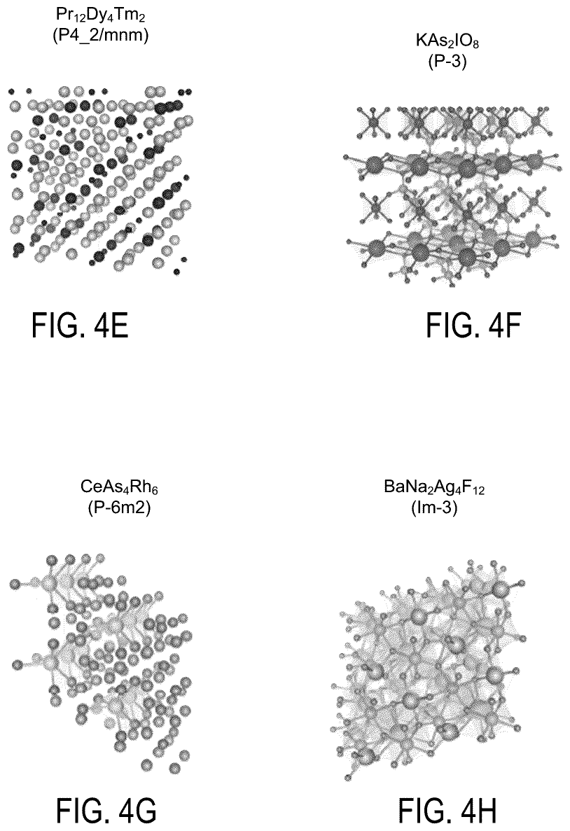

Symmetry is one of the most important characteristics for crystalline materials. It defines the symmetry of the electronic and phonon band structure, thus directly affecting the electronic and vibrational properties, and is also a determining factor for the topological and ferroelectric properties. Designing novel, stable materials with target symmetry is challenging, because a crystal can be distorted after DFT relaxation to stabilize its initial structure. The present disclosure explores MatterGen's capability to design materials with target symmetry by fine-tuning it on space group labels. FIG. 4A shows that the conditional generative model is able to achieve an average success rate of 20% for generated structures that are stable, novel, unique, and belong to the target space group, across 14 randomly selected space groups, two for each of the seven crystal systems. The dark bars of FIG. 4A show the fraction of conditionally generated stable, novel and unique structures that belong to the space group the MatterGen-L model was conditioned on. The light bars of FIG. 4A show the fraction of structures belonging to that space group in the reference data set. In particular, the present disclosure samples 256 structures per space group, and then computes the stability, novelty, uniqueness, and space group, on the DFT-relaxed samples. The performance is satisfactory also for highly symmetric space groups like P6 3/mmc and Im-3; a surprising result, given how many previous generative models struggled in generating highly symmetric crystals. In FIGS. 4B-4H, seven randomly-sampled stable, novel, unique structures are reported, with each structure belonging to one of the seven crystal systems.

2.5 Designing Materials with Magnetic, Electronic, and Mechanical Properties

There is an enormous need for new materials with desired properties across a wide range of real-world applications, e.g. for designing carbon capture technologies, solar cells, or semiconductors with improved characteristics. However, the classic screening-based paradigm starting from a set of candidates and selecting the ones with the best properties suffers from the massive search space and challenging property constraints required for finding improved materials. In contrast, the present disclosure uses inverse design to enable a user to directly design materials given some target properties input by the user.

The conditional generative model's ability to generate materials with target properties on three different single-property inverse design tasks is evaluated. The tasks feature a diverse set of properties—including a magnetic, electronic, and mechanical property—with varying degrees of available labeled data for fine-tuning the model. In the first task, it was an aim to generate materials with high magnetic density, which is an important property for magnets. The unconditional generative model was fine-tuned on 605,000 structures with DFT magnetic density labels to form a conditional generative model, and the conditional generative model was commanded to generate structures with a magnetic density value of 0.20 Å⁻³. Second, promising candidates for developing semiconductors were explored. The model was fine-tuned on 42,000 structures with DFT band gap labels to form a conditional generative model, and then materials were sampled with a target band gap value of 3.0 eV. Finally, the conditional generative model was used to generate structures with a high bulk modulus—a prerequisite for super-hard materials. The model was fine-tuned on only 5000 labeled structures, and conditionally sampled with a target value of 400 GPa. For each task, 512 structures were sampled from the conditional generative model and filtered by stability (below 0.1 eV/atom of Alex-MP hull), uniqueness, and novelty (with respect to Alex-MP).

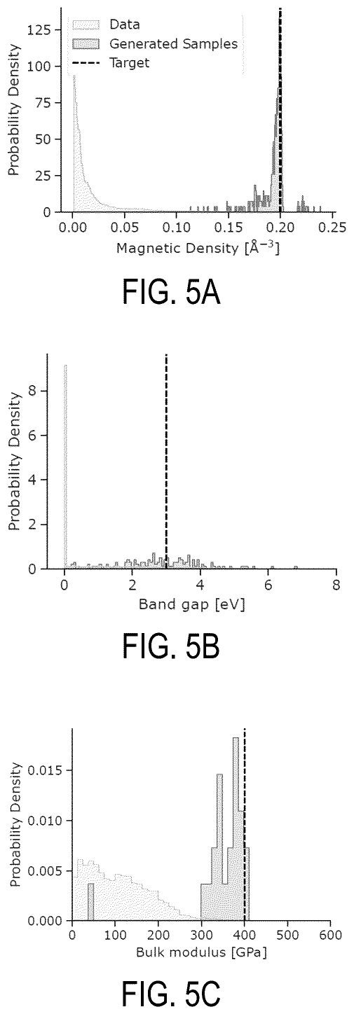

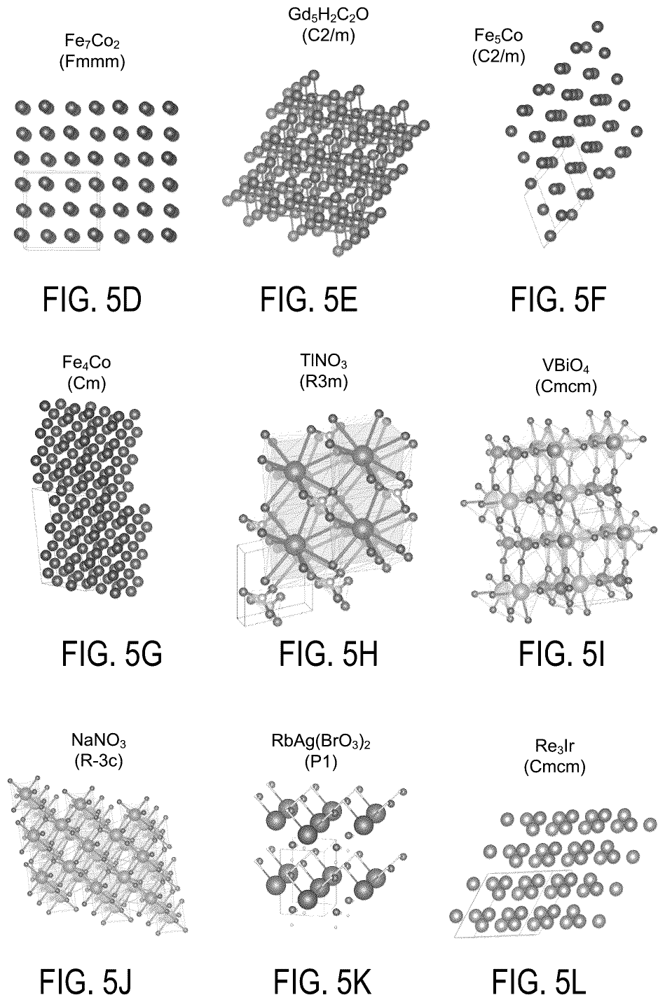

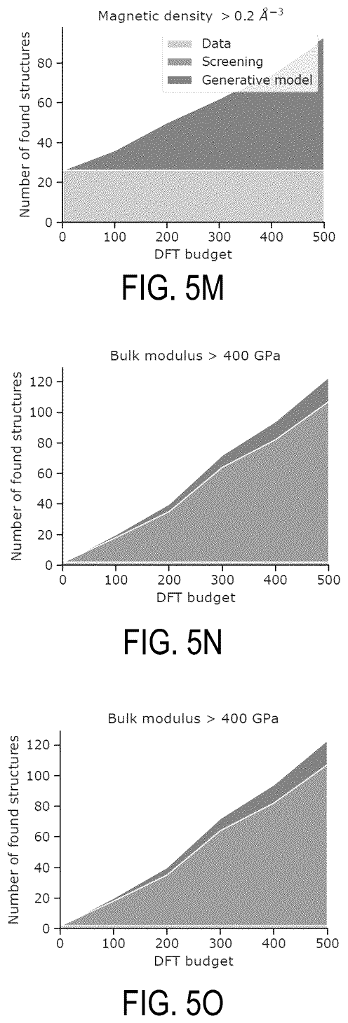

In FIGS. 5A-5C, the density of property values is contrasted among 1) SUN structures generated by the present model, and 2) structures in the data set. As can be seen, there is a significant shift in the distribution of property values among samples generated by the conditional generative model towards the desired property targets, even if the targets are at the tail of the data distribution. In particular, this still holds true as the number of DFT labels available for fine-tuning the model gets reduced significantly. FIGS. 5D-5K shows SUN structures generated by the present conditional generative model with magnetic density>0.2 Å⁻³ (FIGS. 5D-5G), band gap of 3±0.1 eV (FIGS. 5H-K), and bulk modulus>400 GPa (f).

Next, the present disclosure evaluates how many stable and unique structures that satisfy target constraints can be found by different approaches given a range of DFT budgets k∈[100, 200, . . . , 500]. As a baseline, the number of materials is counted in the data set with the desired property. This only includes structures for which a DFT label is available, and thus does not require any additional DFT evaluations. Comparison with a screening approach was performed, which uses a property predictor to rank structures in the data set by their predicted property values, and then chooses the top k structures to be evaluated by DFT. This only considers structures without an existing DFT label, and thus allows the discovery of structures beyond the data baseline. Finally, 15,260 structures are conditionally sampled with the present model and filtered by stability, uniqueness and novelty. Next, k structures are randomly selected and evaluated with DFT. Note that such structures cannot be found by either of the other two baselines due to the novelty filter. See Section F.4 for more details.

The results are shown in FIGS. 5M-5O.

### 2.6 Designing Low-Supply-Chain Risk Magnets

As mentioned above, some material design problems relate to finding materials satisfying multiple constraints. MatterGen can be fine-tuned to generate materials that satisfy combinations of conditions shown earlier. In fact, the present disclosure already shows an example of generating novel materials given target chemical system and energy above the hull in Section 2.3. Here, the present disclosure showcases the capability of the conditional generative model for tackling realistic materials design problems via an example of finding low-supply-chain risk magnets.

Most high performing permanent magnets known to date typically contain rare earth elements, and there has been interest in discovering rare-earth-free permanent magnets, owing to the supply chain risk of such elements. In one example use case, the problem of finding a low-supply-chain-risk magnet can be simplified to finding materials satisfying 2 property constraints: 1) the magnetic density is higher than 0.2 Å⁻³, which is a prerequisite for strong magnets; and 2) the Herfindahl-Hirschman Index (HHI) is lower than 1500, as defined by the U.S. Department of Justice and the Federal Trade Commission as low risk.

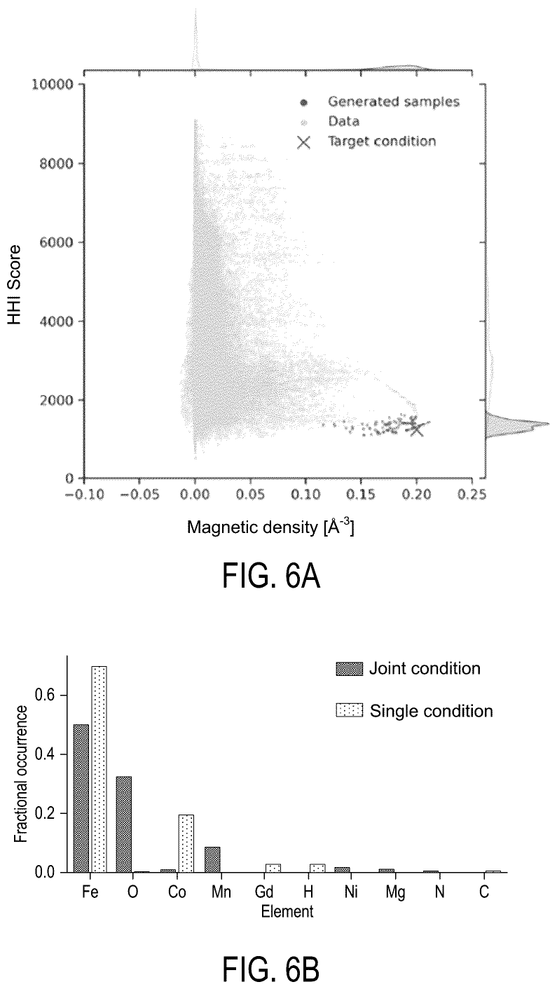

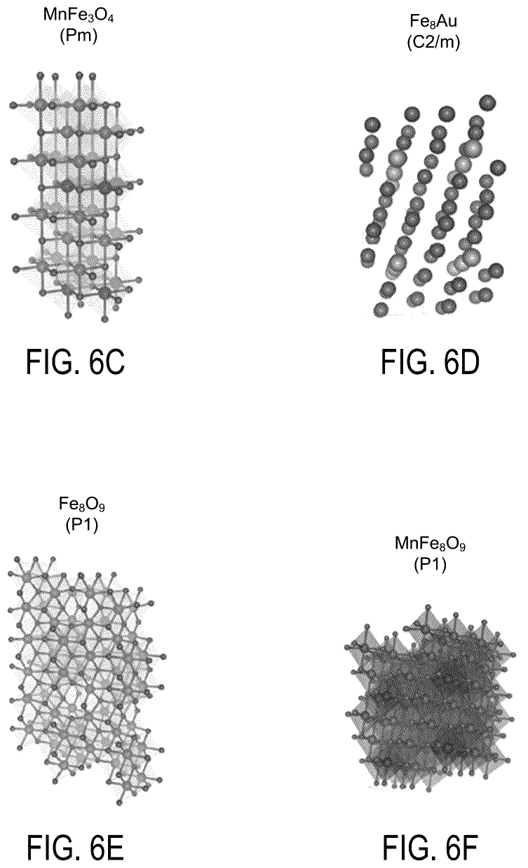

In FIGS. 6A-6F charts and visualizations evaluating the performance of the present conditional generative model in generating candidates for permanent magnetic materials with low supply chain risk is illustrated. The joint distribution of all known magnetic densities and HHI scores in the data distribution, in grey, is shown in comparison to the corresponding distribution of SUN samples generated by conditioning on a magnetic density of 0.2 Å⁻³ and a HHI score of 1250. In FIG. 6A, the SUN materials MatterGen-L generates can be observed to be distributed around the target values, both for magnetic density (x axis) and HHI score (y axis), despite the data distribution being extremely scarce in such region. FIG. 6B showcases the effect of joint conditioning on the HHI score, as elements commonly employed for high-magnetic density materials that have supply chain issues such as Cobalt (Co) and Gadolinium (Gd) are not present in the structures generated by the joint-conditioned model (in purple), while occurring in structures generated by the single-conditioned model (in grey).

### 2.7 Analysis

Assessing the quality of generated crystals is difficult. Traditional methods of crystal generation, such as substitution, will typically start from highly-symmetric prototype crystal structures, which are generally defined with a conventional lattice or otherwise reasonable lattice parameters. While local relaxations would be expected when calculating a substituted crystal, it is generally observed that substituted crystals are close to a local energetic minimum. In contrast, the present method can—in principle—generate crystals outside of any known prototype, which might include real (synthesizable) crystals, but which might also include unrealistic crystals.

While the model will generate something that meets the definition of a crystal in that it has translational symmetry, there are many ways in which a generated crystal might not be physically plausible. For example, a generated crystal might contain a large vacuum region. This is common in the simulation of crystals, for example when simulating a nanoparticle or surface under periodic boundary conditions, but would not be a desired output for this model. Likewise, amorphous materials are commonly simulated under periodic boundary conditions, and could also be generated. In contrast, a 2D material might be represented under periodic boundary conditions with a large vacuum region, and might be an appropriate output. More subtle issues might include the incorporation of defects, whether through structural distortions (resulting in a crystal away from its global minimum, that the DFT optimizer is unable to recover from) or through point defects or otherwise, and the lack of prediction of magnetic order (resulting in crystal with calculated properties different from that of the crystal in its true magnetic ground state).

Some efforts have been made to algorithmically categorize a crystal according to an ontology, which could allow for the preparation of cleaner training data, however these tools are not yet well-developed and, despite best efforts, training data often includes examples of systems that are undesirable for the present task. For example, the Materials Project contains some amount of amorphous materials and surfaces, hybrid organic-inorganic crystals, as well as necessarily a certain amount of molecular crystals.

Evaluation of crystal structures typically goes hand-in-hand with chemical intuition and background knowledge of a particular system. It becomes more difficult for a scientist to evaluate a crystal structure picked “at random”, especially as the number of elements increases. Some metrics cannot be evaluated automatically, either due to a lack of mature algorithmic methods, or because the prior is simply not known; for example, any distribution of a specific property calculated from crystalline materials that have already been synthesized will include bias by not including materials that have not yet been synthesized. These biases can be because certain elements are more abundant, cheaper, or easier to process on Earth, or because certain materials have gathered more technological interest, rather than because of an a priori physical reason why those materials might have been made. Simply put, one does not yet know what the distribution of “possible” crystal structures looks like, even within certain constraints (e.g., maximum primitive cell size or number of elements).

To evaluate generated crystals from the present model, a holistic approach is taken that acknowledges several factors:
1. Structure-based metrics which can be assessed automatically, as previously described.
2. Energy above the convex hull, as previously described. However, while a 0 eV/atom energy above convex hull is a prediction that a given material is thermodynamically stable, it is well known that this is neither a necessary condition nor a guarantee that a material can be synthesized: many metastable materials with finite energy above hulls are routinely synthesized, and many on-hull materials have not been, despite best effort. While some attempts have been made to suggest reasonable threshold values for energy above convex hull, this is very dependent on the chemical system, with some materials (such as carbides, nitrides) able to tolerate very high energies above the convex hull, with other materials (such as intermetallics) only able to tolerate a very small degree of metastability. It is also well-known that traditional methods of simulation using DFT will give inaccurate energies for some materials, even after empirical corrections, if any, are applied. Furthermore, the energy above convex hull is a measure that is only meaningful if the particular chemical system has been well-explored: for unexplored or partially explored chemical systems, the energy above convex hull might be inaccurate simply due to more energetically-favorable phases being unknown.
3. Symmetry. Nature prefers symmetrical crystals; while some degree of symmetry-breaking might be expected as the number of elements in a system increases. In general, generated crystals are expected to be symmetrical, especially since P1 crystals are rare in nature, and often reported in databases either because they have not been refined or even because of mis-identification.
4. Defects. In the examples of bixbyite and fluorite defect limitations can be present, for example.
5. Local atomic environments.
6. Charge balance. The proportion of new materials that have been discovered that are nominally charge-balanced has decreased over time, with around 80% of materials being charge-balanced a hundred years ago, to around only around 40% presently. Charge balancing by formal valence is only appropriate for very ionic systems.
7. Alloying. Any generated crystal might be an alloy, have ordered approximations, etc.

Given these factors, it is acknowledged that there are limitations in materials discovery efforts that still require methods advancements to overcome. Human-assisted evaluation of predicted structures was attempted to gain an intuition for how the present model performs across the tasks presented in this work.

Evaluation of Materials from Unconditional Generation Task

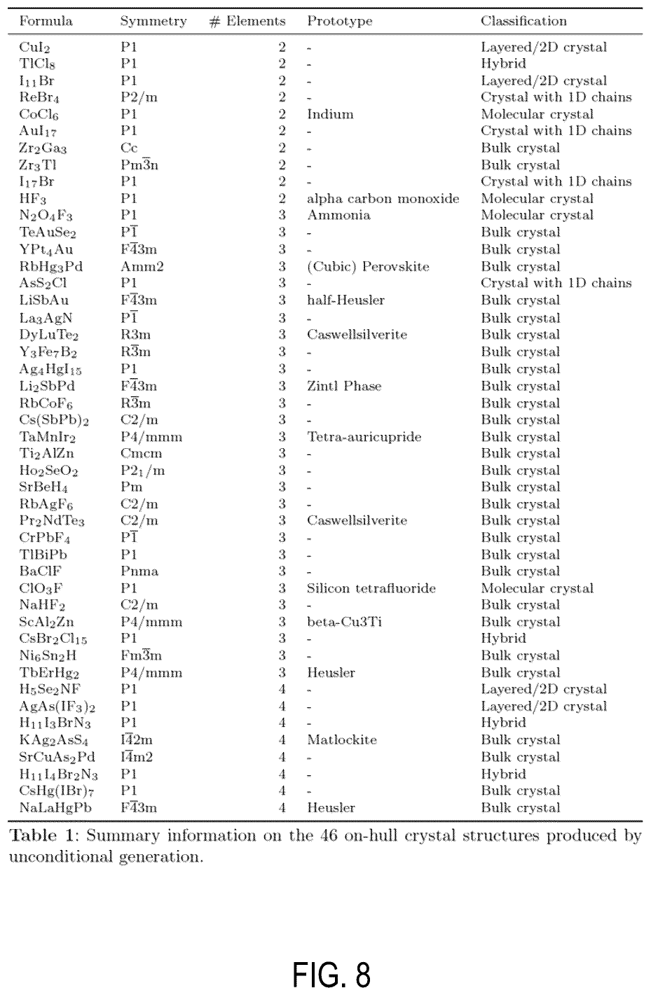

Of a sample of 1024 structures generated unconditionally, there were 46 unique, on-hull crystal structures generated: 10 binaries, 28 ternaries, and 8 quaternaries. These are summarized in Table 1 of FIG. 8. Of these, P1 spacegroups were over-represented, and 4 were molecular crystals, with several more with molecular components.

Evaluation of Materials from Target Chemical System Task

The V—Sr—O chemical system example provided in FIG. 3E produced four new on-hull crystal structures: namely, the SrV₂O₆ (V⁵⁺), SrVO₃ (V⁴⁺), Sr₃V₂O₈ (V⁵⁺) and SrV₂O₄ (V⁴⁺) structures. This chemical system has been well-studied in literature, with SrVO₃ being a well-known perovskite, Sr₂VO₄ expected to crystallize into a K₂NiF-like crystal structure, and Sr₃(VO₄)₂ synthesized in a cation-deficient variant of the SrVO₃ crystal structure.

Vanadates are known to be synthesizable in a variety of frameworks, with the expected co-ordination of the VO₄ sub-unit varying with oxidation state from the ideal tetrahedron in V⁵⁺. All generated structures have plausible atomic environments with VO₄ sub-units, either ideal or distorted, and oxygen coordinated Sr atoms.

### 3 Discussion

As discussed above, the ability to directly generate materials structures given a set of desired properties and characteristics, often called “inverse design”, is the holy grail of computational materials science. However, generating the structure of inorganic materials is challenging due to their periodicity, and due to the interplay between the generation of atom types, coordinates, and lattice. There has been significant progress in generative models for materials like CDVAE, but it suffers from several limitations like being unable to update the lattice shape in the diffusion process and the difficulty of learning a latent space in the autoencoder architecture. The present model, MatterGen, improves upon these limitations by introducing a coordinate diffusion that treats the unit cell as a hypertorus, an atom type diffusion based on a generalization of diffusion process to categorical variables, and a lattice diffusion with a limiting distribution of a cubic lattice with fixed atomic density. These innovations, combined with a significantly larger training dataset, drastically improves the stability, and diversity of generated materials compared with previous methods.

Further, a novel fine-tuning scheme is used that tunes a pre-trained unconditional model to a conditional model that generates materials given different conditions. This capability is important because it is generally significantly more expensive to compute the properties of a material compared to DFT structural relaxation. MatterGen can generate materials with more complex conditions than previous methods, including chemical system, symmetry, different types of properties, and multiple properties. The breadth of these capabilities and the quality of generated materials indicate the broad applicability of MatterGen to various use cases.

The novelty of generated crystals by the present model is around 70% and can be lower in conditionally generated samples. MatterGen can also be extended in several directions. It could be used to generate more complex materials, including metal organic frameworks, high entropy alloys, etc. It can also include more complex properties, like the band structure, x-ray diffraction patterns, etc.

### APPENDIX A SUPPLEMENTARY FIGURES

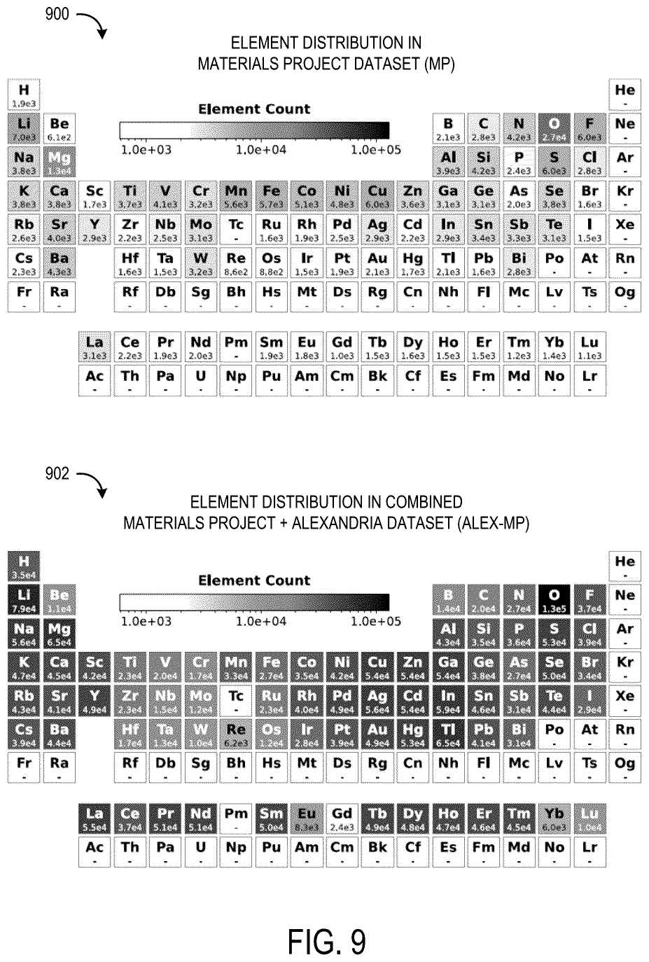

FIG. 9 shows the Supplementary Figures of Appendix A.

### APPENDIX B SUPPLEMENTARY TABLES

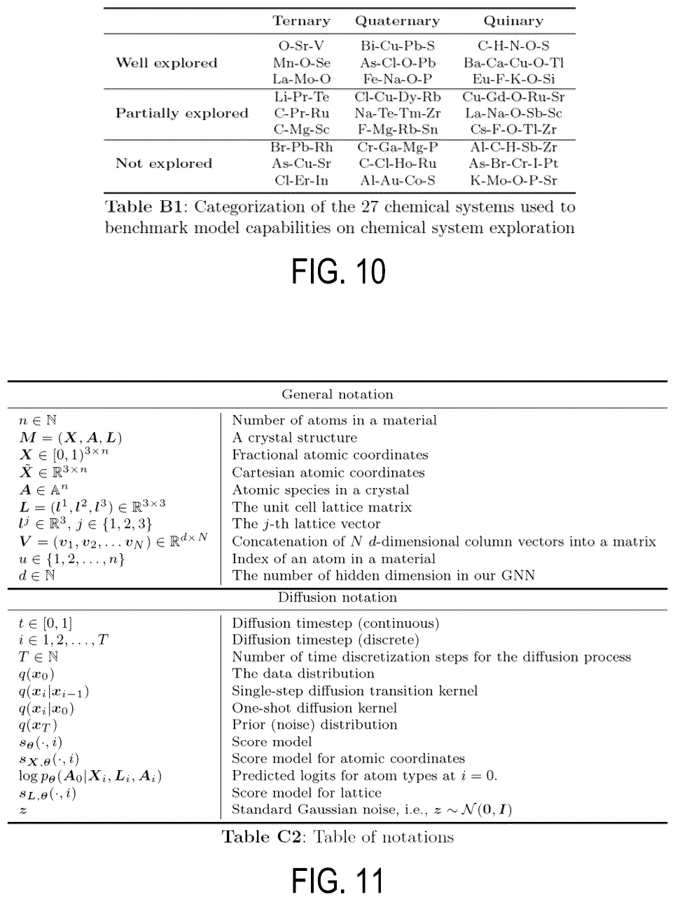

FIG. 10 shows the Supplementary Table B1 of Appendix B.

### APPENDIX C NOTATION TABLE

FIG. 11 shows the Notation Table C1 of Appendix C.

### APPENDIX D DIFFUSION MODEL FOR PERIODIC MATERIALS

Appendix D follows.

### D.1 Representation of Periodic Materials

Any crystal structure can be represented by some repeating unit (called the unit cell) that tiles the complete 3D space. The unit cell itself contains a number of atoms that are arranged inside of it. Thus, the following universal representation is used for a material M:

$$M = ( A , X , L ) \qquad ( D1 )$$

where A=(a¹, a², . . . , aⁿ)^{T}∈ [symbol] ⁿ are the atomic species of the atoms inside the unit cell; L=(l¹, l², l³)∈ [symbol] ^{3×3} is the lattice, i.e., the shape of the repeating unit cell; and X=(x₁, x₂, . . . , xₙ)∈[0,1)^{3×n} are the fractional coordinates of the atoms inside the unit cell.

Fractional coordinates express the location of an atom using the lattice vectors as the basis vectors. For instance, an atom with fractional coordinates x= (0.2,0.3,0.5)^{T} has Cartesian coordinates \tilde{x}=0.2l^{1+0.3}l^{2+0.5}l³. The periodicity in fractional coordinates is defined by the (flat) unit hypertorus, i.e., x=x+k, k∈ [symbol] ³. We can convert between fractional X and Cartesian \tilde{X} coordinates as follows:

$$\tilde{X} = LX \qquad ( D2 )$$

$$X = {L}^{- 1} \tilde{X} \qquad ( D3 )$$

### D.2 Invariance and Equivariance in Periodic Materials

The energy per atom ϵ(M)=E(M)/n of a periodic material M=(X, L, A) has several invariances.
Permutation invariance: ϵ(X, L, A)=ϵ(P(X), L, P(A)) for every permutation matrix P.
Translation invariance: ϵ(X, L, A)=ϵ(X+t, L, A) for every t∈ [symbol] ³.
Rotation invariance: ϵ(X, L, A)=ϵ(X, R(L), A) for every rotation matrix R∈O(3).
Periodic cell choice invariance: ϵ(X, L, A)=ϵ(C⁻¹X, LC, A), where C triangular with det C=1 and C∈ [symbol] ^{3×3}.
Supercell invariance: ϵ(X, L, A)=ϵ(⊕ᵢ₌₀^{det(C)}C⁻¹X+C⁻¹ kᵢ, LC, ⊕ᵢ₌₀^{det(C)}A), where C is a 3×3 diagonal matrix with positive integers on the diagonal, kᵢ∈ [symbol] ³ indexes the cell repetitions in the three lattice components, and ⊕ indicates concatenation.

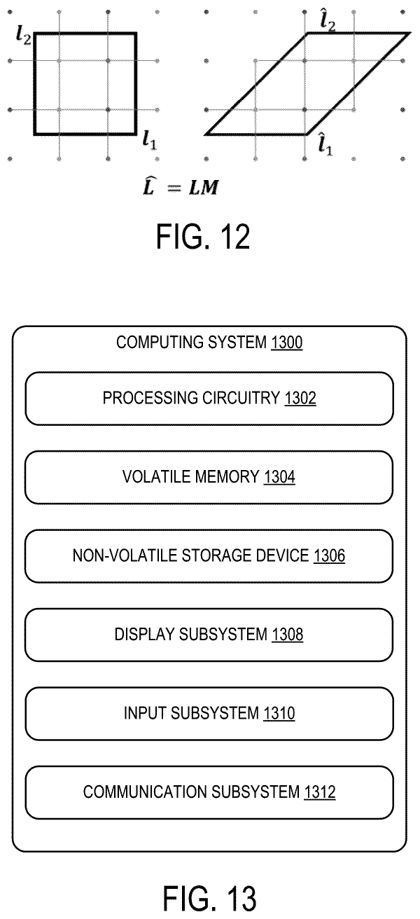

Forces are instead equivariant to permutation and rotation, while being invariant to translation and periodic cell choice. Stress tensors are similarly invariant to permutation, translation, supercell choice, and periodic cell choice; while being L2-equivariant to rotation (see FIG. 12 and Section D.8.1 for additional details).

It has been shown that incorporating the correct physical invariances and equivariances into the model improves performance and data efficiency in many tasks. Therefore, the present disclosure includes the following invariances and equivariances in the present score models. Position scores s_{X,θ} follow the same behaviour as force vectors, being equivariant to permutation and rotation, and invariant to translation. Atom type predictions log p_{θ}(A₀|Xᵢ, Lᵢ, Aᵢ) are equivariant to permutation, and invariant to translation, rotation. Lattice scores SLe are invariant to translation, permutation, and supercell choice, while being L2-equivariant to rotation (see Section D.8.1 for additional details). It is noted that the present disclosure chooses to forgo the invariance of scores to periodic cell choice to improve performance, as explained in Section D.8.2.

### D.3 Diffusion Probabilistic Modeling Background and Notation

### D.3.1 Denoising Score Matching

Denoising score matching (DSM) models are a class of score-based generative models, i.e., models which approximate the score of the data distribution. They utilize the result from Vincent that training a denoising autoencoder is equivalent to performing score matching on a Parzen density estimate of the data distribution.

More specifically, DSM models define a series of noise kernels qᵢ(xᵢ|x₀)= [symbol] (xᵢ; x₀, σᵢ²I), with 0<i≤T∈ [symbol] , inducing noisy distributions qᵢ(xᵢ)=∫q_{data}(x₀)qᵢ(xᵢ|x₀)dx₀. The standard deviation σᵢ typically increases exponentially with increasing i, until some predefined maximum value σ_{T}=σₘₐₓ is reached. DSM learns a Noise-conditional score model denoted by s_{θ}(x, i): [symbol] ^{d}× [symbol] ₊→ [symbol] ^{d} via a weighted sum of denoising score matching objectives, where d is the data dimension:

$${θ}^{*} = {arg min}_{θ} {\sum }_{i = 1}^{T} {σ}_{i}^{2} {𝔼}_{q ( {x}_{0} )} {𝔼}_{q ( {x}_{i} \vert {x}_{0} )} [ {‖ {s}_{θ} ( {x}_{i} , i ) - {∇}_{{x}_{i}} log q ( {x}_{i} \vert {x}_{0} ) ‖}_{2}^{2} ] \qquad ( D4 )$$

Assuming sufficient data and model capacity, the learned score s_{θ}·(xᵢ, i) matches the score of the noise distributions ∇ₓ_{ᵢ} log qᵢ(xᵢ|x₀) almost everywhere for 0<i≤T∈ [symbol] , and the present disclosure can sample from the distribution via annealed Langevin dynamics.

### D.3.2 Denoising Diffusion Probabilistic Models

Denoising diffusion probabilistic models (DDPMs) are a class of generative models that learn to revert a diffusion process that gradually adds noise to an input sample. The diffusion process is determined by a sequence of positive noise scales 0<β₁, β₂, . . . β_{T}<1. The transition kernels are defined as

$$q ( {x}_{i} \vert {x}_{i - 1} ) = ( {x}_{i} ; \sqrt{1 - {β}_{i}} {x}_{i - 1} , {β}_{i} I ) \qquad ( D5 )$$

defining a discrete Markov chain {x₁, . . . , x_{T}} for a data point x₀. Because of the closure property of the Normal distribution under addition and scaling, the present disclosure can sample an arbitrary xᵢ in a single step given some x₀:

$$q ( {x}_{i} \vert {x}_{0} ) = ( {x}_{i} ; \sqrt{{\overline{α}}_{i}} {x}_{0} , ( 1 - {\overline{α}}_{i} ) I ) \qquad ( D6 )$$

where α̅ᵢ=Πᵢ₌₁ⁱ(1−βᵢ). For i=1, the present disclosure has α̅₁≈1, and for i=Tα̅_{T}≈0, thus the diffusion process goes from q(x₁|x₀)≈δ(x₀) to q(x_{T}|x₀)≈ [symbol] (0, I). The training objective of DDPM is similar to the DSM objective from Eq. (D4):

$${θ}^{*} = {arg min}_{θ} {\sum }_{i = 1}^{T} ( 1 - {\overline{α}}_{i} ) {𝔼}_{q ( {x}_{0} )} {𝔼}_{q ( {x}_{i} \vert {x}_{0} )} [ {‖ {s}_{θ} ( {x}_{i} , i ) - {∇}_{{x}_{i}} log q ( {x}_{i} \vert {x}_{0} ) ‖}_{2}^{2} ] \qquad ( D7 )$$

Sampling from a model obtained from Eq. (D7) works via ancestral sampling from the graphical model Πᵢ₌₁^{T}p_{θ}(xᵢ₋₁|xᵢ):

$${x}_{i - 1} = \frac{1}{\sqrt{1 - {β}_{i}}} ( {x}_{i} + {β}_{i} {s}_{θ} * ( {x}_{i} , i ) ) + \sqrt{{β}_{i}} z \qquad ( D8 )$$

starting from X_{T}˜ [symbol] (0, I), where z is standard Gaussian noise.

### D.4 Joint Diffusion Process

In the present crystal diffusion process, the atom coordinates, atomic numbers, and the lattice are diffused simultaneously and independently. The general form of the joint distribution is

$$q ( {X}_{i + 1} , {L}_{i + 1} , {A}_{i + 1} \vert {X}_{i} , {L}_{i} , {A}_{i} ) = q ( {X}_{i + 1} \vert {X}_{i} ) q ( {L}_{i + 1} \vert {L}_{i} ) q ( {A}_{i + 1} \vert {A}_{i} ) \qquad ( D9 )$$

In addition, diffusion of the atom species and fractional coordinates factorizes into the diffusion of the individual atoms:

$$q ( {X}_{i + 1} \vert {X}_{i} ) = {\prod }_{u = 1}^{n} q ( {x}_{i + 1}^{u} \vert {x}_{i}^{u} ) \qquad ( D10 )$$

$$q ( {A}_{i + 1} \vert {A}_{i} ) = {\prod }_{u = 1}^{n} q ( {a}_{i + 1}^{u} \vert {a}_{i}^{u} ) \qquad ( D11 )$$

Note the factorization of the forward diffusion process does not imply that the reverse diffusion process factorizes in the same way. In the following, the present disclosure describes the details of the three separate forward diffusion processes.

### D.5 Atom Type Diffusion

For the diffusion of the (discrete) atom species A, the present disclosure uses the discrete denoising diffusion probabilistic model (D3PM), which is a generalization of DDPM to discrete data problems, and is limited to discrete-time settings. As in DDPM, the forward diffusion process is a Markov process that gradually corrupts an input sample a₀, which is a scalar discrete random variable with K categories (e.g., atomic species):

$$q ( {a}_{1 : T} \vert {a}_{0} ) = {\prod }_{i = 1}^{T} q ( {a}_{i} \vert {a}_{i - 1} ) \qquad ( D12 )$$

where a₀˜q(a₀) is an atomic species sampled from the data distribution and a_{T}˜q(a_{T}), where q(a_{T}) is a prior distribution that is easy to sample from.

Denoting the one-hot version of a as a row vector a, the transitions can be expressed as:

$$q ( {a}_{i} \vert {a}_{i - 1} ) = C a t ( {a}_{i} ; p = {a}_{i - 1} {Q}_{i} ) \qquad ( D13 )$$

where [Qᵢ]ᵤᵥ=q(aᵢ=v|aᵢ₋₁=u) is the Markov transition matrix at time step i. Cat (a; p) is a categorical distribution over one-hot vectors whose probabilities are given by the row vector p. Similar to DDPM, D3PM assumes that the forward diffusion factorizes over all discrete variables of a datapoint, i.e., all atomic species are diffused independently with the same transition matrices Qᵢ, hence the present disclosure only considers individual one-hot vectors in this section.

D3PMs are trained by optimizing a variational lower bound:

$${L}_{v b} = {𝔼}_{q ( {a}_{0} )} [ {D}_{K L} [ q ( {a}_{T} \vert {a}_{0} ) ‖ q ( {a}_{T} ) ] + {\sum }_{i = 2}^{T} {𝔼}_{q ( {a}_{i} \vert {a}_{0} )} [ {D}_{K L} [ q ( {a}_{i - 1} \vert {a}_{i} , {a}_{0} ) ‖ {p}_{θ} ( {a}_{i - 1} \vert {a}_{i} ) ] ] - {𝔼}_{q ( {a}_{1} \vert {a}_{0} )} [ log {p}_{θ} ( {a}_{0} \vert {a}_{1} ) ] ]$$

In addition, an additional auxiliary cross-entropy loss on the model's prediction p_{θ}(a₀|a₁) is proposed:

$${L}_{C E} = - {𝔼}_{q ( {a}_{0} )} [ {\sum }_{i = 2}^{T} {𝔼}_{q ( {a}_{i} \vert {a}_{0} )} [ log {p}_{θ} ( {a}_{0} \vert {a}_{i} ) ] ]$$

so that the overall loss becomes

$$L = {L}_{v b} + λ {L}_{C E} \qquad ( D14 )$$

Three important characteristics of DDPM and DSM models are that (i) given x₀ the present disclosure can sample noisy samples xᵢ for arbitrary i in constant time; (ii) after sufficiently many diffusion steps, x_{T} follows a prior distribution that is easy to sample from; and (iii) the posterior q(xᵢ₋₁|xᵢ, x₀) in Eq. (D14) is tractable and can be computed efficiently. D3PM also has these properties, as briefly outlined in the following.
(i) fast sampling of aᵢ˜q(aᵢ|a₀). Since the forward diffusion in D3PM is governed by discrete transition matrices {Qᵢ}ᵢ₌₁^{T}, this can be expressed

$$q ( {a}_{i} \vert {a}_{0} ) = C a t ( {a}_{i} ; p = {a}_{i - 1} {\overline{Q}}_{i} ) , where {\overline{Q}}_{i} = {Q}_{1} {Q}_{2} … {Q}_{i} \qquad ( D15 )$$

The cumulative transition matrices Q̅ᵢ can be precomputed and for many diffusion processes even have a closed form.
(ii) Tractable prior distribution. Two of the proposed diffusion processes are the absorbing (which the present disclosure employs in MatterGen) and uniform diffusion processes. Both gradually diffuse the data towards a stationary distribution, which are the one-hot distribution on the absorbing state and the uniform distribution over all categories, respectively.
(iii) Tractable posterior q(aᵢ₋₁|aᵢ, a₀). Using the Bayes rule and exploiting the Markov property q(aᵢ|aᵢ₋₁, a₀)=q(aᵢ|aᵢ₋₁), this can be expressed

$$q ( {a}_{i - 1} \vert {a}_{i} , {a}_{0} ) = \frac{q ( {a}_{i} \vert {a}_{i - 1} ) q ( {a}_{i - 1} \vert {a}_{0} )}{q ( {a}_{i} \vert {a}_{0} )} \qquad ( D16 )$$

All terms in Eq. (D16) can be computed efficiently in closed form given the forward diffusion process.

Reverse sampling process. A sample was generated by sampling a_{T} and then gradually updating the sample to obtain p_{θ}(a_{0:T})=q(a_{T})Πᵢ₌₁^{T}p_{θ}(aᵢ₋₁|aᵢ). Parameterization p_{θ}(aᵢ₋₁|aᵢ) is proposed by predicting a distribution over a₀ and then marginalizing it out:

$${p}_{θ} ( {a}_{i - 1} \vert {a}_{i} ) ∝ {\sum }_{{a}_{0}} q ( {a}_{i - 1} , {a}_{i} \vert {a}_{0} ) {p}_{θ} ( {a}_{0} 1 {a}_{i} ) \qquad ( D17 )$$

where the tractable posterior computation can be used again. Since there is a discrete state space, marginalizing out a₀ by explicit summation has complexity O(K); in the case of atomic species K=O(100), thus this is relatively cheap. This parameterization has the advantage that potential sparsity in the diffusion process is efficiently enforced by using q(aᵢ₋₁, aᵢ|a₀) without having to be learned by the model.

Forward diffusion process. As the specific flavor of D3PM forward diffusion, a masked diffusion process is employed, which has shown best performance. More concretely, an extra atom species [MASK] is introduced at index K−1 which is the absorbing or masked state. At each timestep i, the transition matrices have the particularly simple form

$${[ {Q}_{i}^{absorbing} ]}_{u v} = \{ \begin{matrix}1 & if u = v = m \\ 1 - {β}_{i} & if u = v \neq m \\ {β}_{i} & if v = m \neq u \\ 0 & if m \neq u \neq v \neq m\end{matrix} \qquad ( D18 )$$

where m corresponds to the absorbing state. Intuitively, each species has probability 1−βᵢ of staying unchanged, and probability βᵢ of transitioning to the absorbing state. Once a species is absorbed, it can never leave that state, and there are no transitions between different non-masked atomic species. Thus, the stationary distribution of this diffusion process is a point mass on the absorbing state.

### Corrector Algorithm for D3PM.

### D.6 Coordinate Diffusion

For the present model diffusion is performed on the fractional coordinates and outline the approach in the following. See Section D.6.3 for a brief outline why fractional coordinate diffusion is favored over Cartesian. The atomic coordinates in a crystal structure live in a Riemannian manifold referred to as the flat torus [symbol] ³, which it is viewed as the quotient space [symbol] ³/ [symbol] ³ with equivalence relation:

$$x + k ∼ x , k ∈ {ℤ}^{3} \qquad ( D19 )$$

Thus, adding Gaussian noise to fractional coordinates naturally corresponds to sampling from a wrapped Normal distribution, whose probability density is defined as

$${W}_{} ( \overline{x} ; x , {σ}^{2} I ) = {\sum }_{k ∈ {ℤ}^{3}} ( \overline{x} ; x - k , {σ}^{2} I ) \qquad ( D20 )$$

For the diffusion of the atom coordinates the DSM approach of exponentially increasing variance over diffusion time is followed. This has the advantage that the prior distribution q(x_{T}) is particularly simple, i.e., the uniform distribution in the range [0,1)³. This approach is used for torsional angles—which live in a 1 D flat torus—in small molecule generation. The one-shot noising process of the fractional coordinates is therefore defined as

$$q ( {x}_{i} \vert {x}_{0} ) = {w}_{} ( {x}_{i} ; {x}_{0} , {σ}_{i}^{2} I ) \qquad ( D21 )$$

### D.6.1 Variance Adjustment for Atomic Density

To reason about the coordinate distribution in Cartesian space the distribution of the Cartesian coordinates \tilde{x}ᵢ can be expressed via the linear transformation of a Gaussian random variable xᵢ:

$$q ( {\tilde{x}}_{i} , \vert {x}_{0} , {L}_{i} ) = {W}_{} ( {L}_{i} {x}_{0} , {σ}_{t}^{2} {L}_{i} {L}_{i}^{T} , {L}_{i} ) \qquad ( D22 )$$

where [symbol] (μ, Σ, L) denotes a wrapped Normal distribution with mean μ, covariance matrix Σ, and periodic boundaries L. Observe that the covariance matrix of the noisy Cartesian coordinates, i.e., Σᵢ=σᵢ²LᵢLᵢ^{T}, depends on the lattice. Thus, the (generalized) variance of the noise distribution also depends on the size of the unit cell, i.e., |det(Σᵢ)|=(σᵢ³|det Lᵢ|)². Assuming roughly constant atomic density

$$d ( {L}_{i} ) = \frac{n}{Vol ( {L}_{i} )} ∝ 1 ⇔ Vol ( {L}_{i} ) = \vert det {L}_{i} \vert ∝ n ,$$

this has the side effect that generally larger variance for coordinates of crystals with more atoms in the unit cell would result. This is undesired, as simply choosing a supercell with more atoms in it will lead to different noise distributions for the individual atoms, even though they describe physically identical materials. Therefore, σᵢ is scaled accordingly, i.e.,

$${σ}_{i}^{′} = \frac{{σ}_{i}}{\sqrt[3]{n}} ,$$

such that

$$\vert det ( {Σ}_{i} ) \vert = {( \frac{{σ}_{i}^{3}}{n} \vert det {L}_{i} \vert )}^{2}$$

is no longer proportional to n.

### D.6.2 Score Computation

Note that for the wrapped normal in Eq. (D20), (log-)likelihood and score computation are intractable because of the infinite sum. However, given the thin tails of the Normal distribution, both can be approximated reasonably well with a truncated sum. More specifically, the score function of the isotropic wrapped Normal distribution, which is crucial for training diffusion models (see Eq. (D4)), can be expressed as

$${∇}_{\overline{x}} log {q}_{σ} ( \overline{x} \vert x ) = {\sum }_{k ∈ {ℤ}^{3}} {w}_{k} \frac{\overline{x} - x + k}{{σ}^{2}} \qquad ( D23 )$$

$$where$$

$${w}_{k} = \frac{1}{Z} exp ( - \frac{\overline{x} - x + k {2}^{}}{2 {σ}^{2}} ) , = {\sum }_{{k}^{′} ∈ {ℤ}^{3}} exp ( - \frac{\overline{x} - x + {k}^{′} {2}^{}}{2 {σ}^{2}} ) \qquad ( D24 )$$

### D.6.3 Fractional Vs Cartesian Coordinate Diffusion

Unlike the present model, CDVAE diffuses the Cartesian instead of fractional coordinates. This approach, however, is not suitable for the present framework. To see this, note that in CDVAE, the lattice L is fixed during the diffusion of the atom coordinates. In the present framework, on the other hand, the lattice is simultaneously diffused to the atom coordinates (and atomic species), which makes diffusion of Cartesian coordinates dependent on the lattice diffusion. This is because the wrapped Normal's covariance matrix and periodic boundaries at diffusion timestep i depend on knowing the lattice matrix Lt; the present diffusion process from Eq. (D9) no longer factorizes into lattice and coordinates and needs to be adapted:

$$q ( {\tilde{X}}_{i + 1} , {L}_{i + 1} , {A}_{i + 1} \vert {\tilde{X}}_{i} , {L}_{i} , {A}_{i} ) = q ( {\tilde{X}}_{i + 1} \vert {\tilde{X}}_{i} , {L}_{i + 1} , {L}_{i} ) q ( {L}_{i + 1} \vert {L}_{i} ) q ( {A}_{i + 1} \vert {A}_{i} ) \qquad ( D25 )$$

Here, the present approach conditions q(\tilde{X}ᵢ₊₁) on Lᵢ₊₁ and Lᵢ because in order to convert the Cartesian coordinates at time step i to time step i+1 first \tilde{x}ᵢ is converted to fractional coordinates using Lᵢ⁻¹, and then to Cartesian coordinates at i+1 using Lᵢ₊₁. The one-shot distribution of noisy Cartesian coordinates (similar to Eq. (D21) for the fractional case) becomes:

$$q ( {\tilde{x}}_{i} \vert {\tilde{x}}_{0} ) = {W}_{} ( {L}_{i} {L}_{0}^{- 1} {\tilde{x}}_{0} , {L}_{i} ( {\sum }_{{i}^{′} = 1}^{i} {σ}_{{i}^{′}}^{2} {{L}_{{i}^{′}}^{- 1} ( {L}_{{i}^{′}}^{T} )}^{- 1} ) {L}_{i}^{T} , {L}_{i} ) \qquad ( D26 )$$

Observe the entire trajectory of noisy lattices L1, . . . , Lᵢ is used in order to express the noise distribution of the Cartesian atomic coordinates. This means that first the entire diffusion trajectory of the lattice would need to be sampled, which is slow. Further, computing the one-shot covariance matrix for the Cartesian coordinates is numerically unstable for long diffusion trajectories. Therefore, the diffusion process of fractional coordinates described in the previous section is used for the present model.

### D.7 Lattice Diffusion

In addition to the diffusion of the atom types and coordinates described above, the present approach also diffuses and denoises the unit cell L in the present framework. The DDPM framework was chosen as the starting point, as the exploding variance of the DSM framework would lead to extremely large unit cells in the noisy limit, which are challenging to handle for a GNN with a fixed edge cutoff.

### D.7.1 Fixed-Rotation Lattice Diffusion

Further, as the distribution of materials is invariant to global rotation, the present approach can either choose a rotation-invariant prior distribution over unit cells, or decide on a canonical rotational alignment that the present disclosure uses throughout diffusion and denoising. The latter was chosen as it gives more flexibility designing the diffusion process. Here, the lattice is represented as a symmetric matrix, via the polar decomposition based on the SVD:

$$\begin{matrix}L = U \tilde{L} & U = W {V}^{T} & \tilde{L} = V Σ {V}^{T}\end{matrix} \qquad ( D27 )$$

where W and V are the left and right singular vectors of L, respectively, and Σ is the diagonal matrix of singular values. U is a rotation matrix and \tilde{L} is a symmetric positive-definite matrix.

The entire forward lattice diffusion is restricted to symmetric matrices by enforcing the noise on the lattice, z∈ [symbol] ^{3×3} to be symmetric, e.g., by only modeling the uppertriangular part of the matrix and mirroring it to the lower triangular part. Notice that this is effectively fixing the rotation, i.e., resulting in six degrees of freedom. Going forward, only lattices and lattice noise which is symmetric are considered.

D.7.2 Lattice Diffusion with Custom Stationary Mean and Variance

All three lattice vectors were diffused independently following the DDPM framework. The forward diffusion is expressed in matrix form

$$q ( {L}_{i} \vert {L}_{0} ) = ( \sqrt{{\overline{α}}_{i}} {L}_{0} , ( 1 - {\overline{α}}_{i} ) I ) \qquad ( D28 )$$

For large i, it is observed that the resulting unit cells tend to have very small volume and steep angles, which means that the atoms are extremely densely packed inside the noisy cells. Therefore, the diffusion process is modified as follows:

$$q ( {L}_{i} \vert {L}_{0} ) = ( \sqrt{{\overline{α}}_{i}} {L}_{0} + ( 1 - \sqrt{{\overline{α}}_{i}} ) μ ( n ) I , ( 1 - {\overline{α}}_{i} ) {σ}_{i}^{2} ( n ) I ) \qquad ( D29 )$$

The following limit distribution is obtained:

$$q ( {L}_{T} ) = ( μ ( n ) I , {σ}_{i}^{2} ( n ) I ) \qquad ( D30 )$$

Thus, in the limit distribution, there is a tendency towards cubic lattices (i.e., the scaled identity lattice matrix), which often occur in nature, have a relatively narrow range of volumes. Further, the lattice vector angles when sampling from the prior are mostly concentrated between 60° and 120°, which aligns well with the initialization range of angles in ab-initio random structure search (AIRSS).

Recall that the volume of a parallelepiped L can be computed by |det L|. By introducing a scalar coefficient μ(n) which depends on the number of atoms in the cell the atomic density of the mean noisy lattice is made roughly constant for differently sized systems. Setting μ(n)=∛\sqrt{nc} the volume of the prior mean becomes Vol(∛\sqrt{nc}I)=nc, thus the atomic density of the prior mean becomes

$$d ( μ ( n ) I ) = \frac{n}{Vol ( μ ( n ) I )} = \frac{1}{c} .$$

It will be appreciated that c can be set to the inverse average density of the dataset as a reasonable prior.

Similarly, the present approach proposes to adjust the variance in the limit distribution t→∞ to be proportional to the volume, such that the signal-to-noise ratio of the noisy lattices is constant across numbers of nodes. Thus, the limit standard deviation can be set as σ(n)=∛\sqrt{nv}. Thus, for a diagonal entry of the lattice matrix the signal-to-noise-ratio in the limit is

$${lim}_{t \to ∞} \frac{\vert μ ( n ) \vert}{σ ( n )} = \frac{\sqrt[3]{nc}}{\sqrt[3]{nv}} = {( \frac{c}{v} )}^{1 / 3}$$

and therefore independent of the number of atoms.

### D.8 Architecture of the Score Network

An SE(3)-equivariant graph neural network (GNN) is employed to predict scores for the lattice, atom positions, and atom types in the denoising process. In particular, the GemNet-dT architecture is adapted, originally developed to be a universal machine learning force field. GemNet is a symmetric message-passing GNN that uses directional information to achieve SO(3)-equivariance, and incorporates 2 and 3-body information in the first layer for efficiency. Since the present approach does not predict energies, the direct (i.e., non conservative) force prediction variant of the model, named GemNet-dT, which has been shown to be more computationally efficient and accurate in these scenarios, is adopted. 4 message-passing layers are employed, a cutoff radius of 7 Å for the neighbor list construction, and set the dimension of nodes and edges hidden representations to 512.

The model is trained to predict Cartesian coordinate scores s_{X,θ}(Xᵢ, Lᵢ, Aᵢ, i) as if they were non-conservative forces, therefore following the standard GemNet-dT implementation. These Cartesian coordinate scores are then transformed into fractional scores following Eq. (D2). (Unnormalized) log-probabilities log p_{θ}(A₀|Xᵢ, Lᵢ, Aᵢ) of the atomic species at i=0 are instead computed as:

$$log {p}_{θ} ( {A}_{0} \vert {X}_{i} , {L}_{i} , {A}_{i} ) = {H}^{( L )} W \qquad ( D31 )$$

where H^{(L)}∈ [symbol] ^{n×d} are the hidden representations of nodes at the last messagepassing layer L, and W∈ [symbol] ^{d×K} are the weights of a fully-connected linear layer, with K being the number of atom types (including the masked null state).

### D.8.1 Computation of the Predicted Lattice Scores

To predict the lattice scores s_{L,θ}(Xᵢ, Lᵢ, Aᵢ, i), the present disclosure utilizes the model's hidden representations of the edges. For layer l, the present disclosure denotes the edge representation of the edge between atoms u and v as mᵤᵥₖ^{l}∈ [symbol] ^{d}, where u is inside the unit cell and v is k∈ [symbol] ³ unit cells displaced from the center unit cell. An MLP ϕ^{l}: [symbol] ^{d}→ [symbol] is used to predict a scalar score per edge. This is treated as a prediction by the model indicating by how much an edge's length should increase or decrease, and translate this into a predicted transformation of the lattice via chain rule derivation:

$$\frac{\partial {\tilde{d}}_{u v k}}{\partial {L}_{i}} = \frac{\partial }{\partial {L}_{i}} {‖ {L}_{i} ( {x}_{i}^{v} - {x}_{i}^{u} + k ) ‖}_{2} \qquad ( D32 )$$

$$= \frac{1}{{\tilde{d}}_{u v k}} {L}_{i} ( {x}_{i}^{v} - {x}_{i}^{u} + k ) \cdot {( {x}_{i}^{v} - {x}_{i}^{u} + k )}^{T} \qquad ( D33 )$$

$$= \frac{1}{{\tilde{d}}_{u v k}} {{\tilde{d}}_{u v k} ( {d}_{u v k} )}^{T} \qquad ( D34 )$$

where \tilde{d}ᵤᵥₖ=∥\tilde{d}ᵤᵥₖ∥₂ is the edge length in Cartesian coordinates, \tilde{d}ᵤᵥₖ=Lᵢ(xᵢ^{v}−xᵢ^{u}+k) is the edge displacement in Cartesian coordinates, and dᵤᵥₖ=xᵢ^{v}−xᵢ^{u}+k is the edge displacement in fractional coordinates. The predicted lattice score per edge is then

$${ϕ}^{l} ( {m}_{uvk}^{l} ) \cdot \frac{\partial {\tilde{d}}_{uvk}}{\partial {L}_{i}} .$$

These predicted scores are averaged over all edges to get the predicted lattice score for layer l:

$${\hat{s}}_{L , θ}^{l} ( {X}_{i} , {L}_{i} , {A}_{i} , i ) = \frac{1}{\vert ε \vert} {\sum }_{( u v k ) ∈ ε} {ϕ}^{l} ( {m}_{u v k}^{l} ) \cdot \frac{1}{{\tilde{d}}_{u v k}} {{\tilde{d}}_{u v k} ( {d}_{u v k} )}^{T} \qquad ( D 35 )$$

Stacking the model's predictions into a diagonal matrix Φ^{l}∈ [symbol] ^{|ε|×|ε|}=diag

$$( \frac{{ϕ}^{l} ( {m}_{uvk}^{l} )}{\vert ε \vert \cdot {\tilde{d}}_{uvk}} )$$

this can be written more concisely

$${\hat{s}}_{L , θ}^{l} ( {X}_{i} , {L}_{i} , {A}_{i} , i ) = \tilde{D} {Φ}^{l} {D}^{T} = {L}_{i} D {Φ}^{l} {D}^{T}$$

where \tilde{D}, D∈ [symbol] ^{3×|ε|} are the ‘stacked’ matrices of Cartesian and fractional distance vectors, respectively, with \tilde{D}=LᵢD for structure i. This form reveals that these predicted lattice scores have a key shortcoming: recall from Section D.7.1 that lattice diffusion is performed on the subspace of symmetric lattice matrices. However, the lattice scores from ŝ_{L,θ}^{l}(Xᵢ, Lᵢ, Aᵢ, i) are generally not symmetric matrices, which is addressed with this modification:

$${s}_{L , θ}^{l} ( {X}_{i} , {L}_{i} , {A}_{i} , i ) = {\tilde{s}}_{L , θ}^{l} ( {X}_{i} , {L}_{i} , {A}_{i} , i ) {L}_{i}^{T} \qquad ( D 37 )$$

$$= {L}_{i} D {\tilde{Φ}}^{l} {D}^{T} {L}_{i}^{T} = \tilde{D} {\tilde{Φ}}^{l} {\tilde{D}}^{T} \qquad ( D 38 )$$

$$where {\tilde{Φ}}_{( u v k ) , ( u v k )}^{l} = \frac{{Φ}_{( u vk ) , ( u v k )}^{l}}{{d}_{u v k}} , i . e . , {\tilde{Φ}}^{l} = diag ( \frac{{ϕ}^{l} ( {m}_{u v k} )}{\vert ε \vert \cdot {d}_{u v k}^{2}} ) .$$

Finally, the predicted lattice scores per layer are summed to obtain the final predicted lattice score:

$${s}_{L , θ} ( {X}_{i} , {L}_{i} , {A}_{i} , i ) = {\sum }_{l = I}^{L} {s}_{L , θ}^{l} ( {X}_{i} , {L}_{i} , {A}_{i} , i ) \qquad ( D 39 )$$

The quantity s_{L,θ}(Aᵢ, Xᵢ, Lᵢ, i) is scale-invariant, and L2-equivariant under rotation. The L2-equivariance derives from the way it is composed with the Cartesian coordinate matrix, and the scale invariance is due to the normalization happening inside Φ. In particular, the diagonal entries of Φ related to the edges are normalized three times: they are divided by the total number of edges, and then multiplied twice by the inverse of the norm of the edge vectors. Given these properties, ŝ_{θ} behaves like a symmetric stress tensor σ, since the stress tensor is scale-invariant:

$${σ}^{′} ( λ M ) = σ ( M ) \qquad ( D 40 )$$

and L2-equivariant under the rotation operator R:

$${σ}^{′} ( R M ) = R σ ( R M ) {R}^{T} \qquad ( D 41 )$$

where λ is used to indicate the supercell replication operation, for brevity.
D.8.2 Augmenting the Input with Lattice Information

The chain-rule-based lattice score predictions from Eq. (D39) have shown to lack expressiveness for modeling the score of the present Gaussian forward diffusion in early experiments, which manifests in high training loss and low-quality samples. It is hypothesized that this is because the present periodic GNN model is oblivious to the shape of the lattice, as it only aware of Cartesian distances and angles. For instance, it cannot distinguish the two structures in FIG. 12 (refer to section D.2 above for more details). The present approach proposes to give up the invariance of the PGNN with respect to equivalent choices of the unit cell by injecting lattice information into the internal representations as follows. This is justified as for any structure its reduced cell can be uniquely determined via the Niggli reduction algorithm, and thus this reduction applies to all structures in the training data. Consequently, the present model is able to distinguish equivalent lattices, which leads to the present model being trained to generate structures with their unique Niggli-reduced unit cells.

To achieve this, concatenate to the input edge representations m^{inp}, which are invariant to translation and rotation, the cosines of the angles of the edge vectors with respect to the lattice cell vectors:

$${\hat{m}}_{ijk}^{inp} = ( {m}_{ijk}^{inp} , cos ( {d}_{ijk} , {l}^{1} ) , cos ( {d}_{ijk} , {l}^{2} ) , cos ( {d}_{ijk} , {l}^{3} ) ) \qquad ( D 42 )$$

This additional information allows the model to distinguish the two cases in FIG. 12, while remaining invariant to rotation and translation.

### D.9 Training Loss

The present model is trained to minimize the following loss, which is a sum over the coordinate loss (compare with DSM loss in Eq. (D4)), cell loss (compare with DDPM loss in Eq. (D7)), and atom type loss (compare with D3PM objective in Eq. (D14)):

$$L = {λ}_{coord} {L}_{coord} + {λ}_{cell} {L}_{cell} + {λ}_{types} {L}_{types} \qquad ( D 43 )$$

$$where$$

$${L}_{coord} = {\sum }_{i = 1}^{T} {σ}_{i}^{2} {𝔼}_{q ( {x}_{0} )} {𝔼}_{q ( {x}_{i} \vert {x}_{0} )} [ {‖ {s}_{x , θ} ( {X}_{i} , {L}_{i} , {A}_{i} , i ) - {∇}_{{x}_{i}} log q ( {x}_{i} \vert {x}_{0} ) ‖}_{2}^{2} ] \qquad ( D 44 )$$

$${L}_{cell} = {\sum }_{i = 1}^{T} ( 1 - {\overline{α}}_{i} ) {𝔼}_{q ( {L}_{0} )} {𝔼}_{q ( {L}_{i} \vert {L}_{0} )} [ {‖ {s}_{L , θ} ( {X}_{i} , {L}_{i} , {A}_{i} , i ) - {∇}_{{L}_{i}} log q ( {L}_{i} \vert {L}_{0} ) ‖}_{2}^{2} ] \qquad ( D 45 )$$

$${L}_{types} = {𝔼}_{q ( {a}_{0} )} [ {\sum }_{i = 2}^{T} {𝔼}_{q ( {a}_{i} \vert {a}_{0} )} [ {D}_{K L} [ q ( {a}_{i - 1} \vert {a}_{i} , {a}_{0} ) ‖ {p}_{θ} ( {a}_{i - 1} \vert {X}_{i} , {L}_{i} , {A}_{i} ) ] - {λ}_{CE} log {p}_{θ} ( {a}_{0} \vert {a}_{i} ) ] - {𝔼}_{q ( {a}_{1} \vert {a}_{0} )} [ log {p}_{θ} ( {a}_{0} \vert {X}_{1} , {L}_{1} , {A}_{1} ) ] ] \qquad ( D 46 )$$

For simplicity, Eqs. (D44) and (D46) show the loss only for a single atom's coordinates and specie, respectively; the overall losses for coordinates and atom types sum over all atoms in a structure.

### APPENDIX E FINE-TUNING SCORE NETWORK FOR GUIDED DIFFUSION

### E.1 Classifier-Free Guidance

To generate samples x from the distribution p(x|y) of x conditioned on the value y of a property, classifier-free diffusion guidance is adopted for all conditional samples generated in this work. In classifier-free guidance, samples are drawn from the conditional distribution

$$\begin{matrix}{p}_{γ} ( x \vert y ) ∝ {p ( y \vert x )}^{γ} p ( x ) \\ ∝ {( \frac{p ( x \vert y )}{p ( x )} )}^{γ} p ( x ) \\ ∝ {p ( x \vert y )}^{γ} {p ( x )}^{1 - γ}\end{matrix} \qquad ( E47 )$$

which is perturbed from p(x|y) by the diffusion guidance factor γ.

### E.1.1 Continuous Case

A value of γ=2 is adopted in all experiments reported in this work. The conditional score follows from Eq. (E47) by taking gradients of the logarithm with respect to x,

$${∇}_{x} ln {p}_{γ} ( x \vert y ) = γ γ {∇}_{x} ln p ( x \vert y ) + ( 1 - γ ) {∇}_{x} ln p ( x ) \qquad ( E48 )$$

Practically, learning a conditional score ∇ₓln p(x|y) equates to concatenating a latent embedding of the condition y, z_{y}, to the learned noise ϵ_{θ}(x, z_{y}, i) during score matching. The unconditional score ∇ₓln p(x) equates to providing a null embedding for the condition, ϵ_{θ}(x, z_{y}=null, i) and multiple, N, properties are conditioned on by simply concatenating several conditional embeddings to the input of the score model, ϵ_{θ}(x, z_{y}_{₁}, x_{y}_{₂}, . . . , x_{z}_{_{yN}}, i).

### E.1.2 Discrete Case

The model's task in denoising discrete atom types a is to fit and predict q(aᵢ₋₁|aᵢ, c). This can be rewritten as

q(aᵢ₋₁|aᵢ,c)∝Σₐ_{ₒ}q(aᵢ₋₁,aᵢ|a₀)·q(a₀|aᵢ,c)

Thus the predictive task is to approximate p_{θ}(a₀|aᵢ, c)≈\tilde{q}(a₀|aᵢ, c). Now, on this distribution classifier-free guidance can be performed as follows:

$${\tilde{q}}_{λ} ( {a}_{0} \vert {a}_{i} , c ) ∝ {\tilde{q} ( c \vert {a}_{0} , {a}_{i} )}^{λ} \cdot \tilde{q} ( {a}_{0} \vert {a}_{i} ) = {( \frac{\tilde{q} ( {a}_{0} \vert c , {a}_{i} ) \cdot \tilde{q} ( c \vert {a}_{i} )}{\tilde{q} ( {a}_{0} \vert {a}_{i} )} )}^{λ} \cdot \tilde{q} ( {a}_{0} \vert {a}_{i} ) ∝ {\tilde{q} ( {a}_{0} \vert c , {a}_{i} )}^{λ} \cdot {\tilde{q} ( {a}_{0} \vert {a}_{i} )}^{1 - λ}$$

This guided distribution can be approximated accordingly with an unconditional and a conditional prediction model, i.e., p_{θ}(a₀|c, aᵢ)^{λ}·p_{θ}(a₀|aᵢ)^{1-λ}≈\tilde{q}(a₀|c, aᵢ)²·\tilde{q}(a₀|aᵢ)^{1-λ}. In practice, this product distribution can be expressed in in log space by performing the weighted sum of conditional and unconditional (unnormalized) log probabilities, i.e., log(p_{θ}(a₀|c, aᵢ)^{λ}·p_{θ}(a₀|aᵢ)^{1-λ})=λ log p_{θ}(a₀|c, aᵢ)+(1−λ)log p_{θ}(a₀|xᵢ).

E.2 Fine-Tuning Score Network with ControlNet

Leveraging the large-scale unlabeled Alexandria-Materials Project (Alex-MP) dataset enables MatterGen to generate a broad distribution of stable material structures via reverse diffusion, driven by unconditional scores. To facilitate conditional generation with classifier-free guidance, the property-conditional scores, as delineated in preceding sections, need to be learned through a labeled dataset. However, labeled datasets, often limited in size and diversity, present challenges in learning the conditional scores from scratch.

Therefore, to enable rapid learning of the conditional scores and form a conditional generative model, the present disclosure proposes to fine-tune the unconditional score network with additional trainable adapter modules, while the original model parameters are frozen. The adapter layer is a combination of an MLP layer and a zero-initialized mix-in layers, so the model still outputs the learned unconditional scores at initialization. This is desired because the unconditional scores lead to stable materials, which is a prerequisite for modeling the property conditional distribution of materials. Further, since the unconditional score network's parameters are frozen, the unconditional scores, which are still required for classifier free guidance, are not disturbed in the fine-tuning process.

The additional adapter modules consist of an embedding layer for the property label (f_{embed} detailed in Section E.3) that outputs a property embedding z, and a series of adaptation modules, one before each message-passing layer (4 in total). The adaptation module augments the atom embedding of the original GemNet score network to incorporate property information. Concretely, at the L-th interaction layer, given the property embedding z and the intermediate node hidden representation {Hⱼ^{(L)}}ⱼ₌₁ⁿ, the property-augmented node hidden representation {H′ⱼ^{(L)}}ⱼ₌₁ⁿ is given by:

H′ⱼ^{(L)}=Hⱼ^{(L)}+fₘᵢₓᵢₙ^{(L)}(f_{adapter}(z))·II (property is not null) (E49)

fₘᵢₓᵢₙ^{(L)} is the L-th mix-in layer, which is a zero-initialized linear layer without bias weights. f_{adapter}^{(L)} is the L-th adaptation layer, which is a 2-layer MLP model. The indicator function II (property is not null) ensures the score prediction (unconditional score) is unchanged when no conditional label is given.

For fine-tuning, all score network weights are frozen—only f_{embed}, f_{adapter}^{(L)}, and fₘᵢₓᵢₙ^{(L)} for each layer are trained through the same training objective as the pre-training stage. The frozen score network is able to predict high-quality unconditional scores, and the adapter module contains only one-tenth of the number of parameters of the original score network. The fine-tuning procedure is therefore very computation and sample-efficient, enabling steering the diffusion process to generate structures satisfying the property condition while being stable and novel.

### E.3 Encoding Conditions

In this work, all properties y that are conditioned on are embedded as a fixed-length vector z^{y}∈ [symbol] ^{d}. It is possible to interpret z^{y=null} as the value of the embedding that corresponds to the unconditional score ∇ₓln p(x). Throughout this work an embedding dimension of d=512 is used. For all model instances the null embedding θnull∈ [symbol] ^{d} is learned when training the model.

Chemical system encoding. Chemical system represents the set of elements which the crystal is composed of. The latent embedding for a chemical system is encoded as multiple-hot encoding and represent the null embedding, which corresponds to the unconditional score, as a vector which is also learned during training.

Encoding the space group. The latent embedding of the space group of a crystal is represented via a one-hot encoding and a vector for the null embedding is adopted, which corresponds to the unconditional score, which is also learned during training.

Encoding scalar properties. The latent embedding of scalar properties such as the bulk modulus, magnetic density and band gap is represented via a sinusoidal encoding

$$\begin{matrix}{z}^{y} = \{ \begin{matrix}{θ}^{null} & , y = null \\ {\tilde{z}}_{i}^{y} & , otherwise\end{matrix} \\ {\tilde{z}}_{i}^{y} = \{ \begin{matrix}sin ( y * {ϕ}_{i / 2} ) & , i \% 2 = 0 \\ cos ( y * {ϕ}_{( i - 1 ) / 2} & , i \% 2 = 1\end{matrix} \\ {ϕ}_{k} = exp ( - \frac{k}{2 d} ln ( κ ) ) , k ∈ \{ ℤ \vert 0 \leq k < d / 2 \}\end{matrix} \qquad ( E 50 )$$

where κ is large number such that ϕ_{d}≈0. Throughout this work, κ=10000. A vector represents the null embedding when evaluating the unconditional score, which is also learned during training.

### APPENDIX F

### F.1 Unconditional Generation

To evaluate the performance of a generative model on the task of unconditional generation, both the local stability and the global stability of generated structures was examined. To measure these stabilities, the present disclosure employs two metrics, respectively RMSD from DFT-relaxed structure, and fraction of stable, novel, unique structures found. The former is computed as follows:

$$RMSD = \sqrt{{min}_{P} \frac{1}{N} {\sum }_{n}^{N} {\vert {\tilde{x}}_{P ( n )}^{gen} - {\tilde{x}}_{n}^{DFT} \vert}^{2}} \qquad ( F 51 )$$

where \tilde{x}n indicates the Cartesian coordinates of atom n, and P is the element-aware permutation operator on the atoms of the generated structure. Lower RMSD indicates that generated structures are closer to their DFT-relaxed counterpart, this in turn saves computational time for the DFT relaxation, which is typically the most costly part of crystal structure generation. The fraction of SUN structures is defined as the fraction of DFT-relaxed structures that lie within 0.1 eV/atom of the known convex hull (stable), are not duplicates of any other generated structure by the same method (unique), and are not duplicates of structures that exist in the reference data set (unique). These two metrics are computed on 10240 generated structures which are then relaxed using the present DFT relaxation protocol both for the present method and all benchmarks the present disclosure includes for the unconditional generation task.

### F.2 Conditioning on Chemical System

The capability of the present model to find novel stable crystals in an array of chemical systems is explored, and reported in Table B1. The systems are divided in terms of how many elements they contain (ternary, quaternary, and quinary), and in terms of how many structures on the convex hull were present in data gathered (‘well explored’, ‘partially explored’, ‘not explored’). The latter classes are defined as follows: ‘well explored’—the systems with the highest numbers of structures on the convex hull, ‘partially explored’—systems that lie between the 30th and the 90th percentile of the distribution of structures on the convex hull, ‘not explored’—systems with no data on the convex hull. For all three groups, chemical systems are chosen in a semi-random fashion, avoiding pairs of chemical systems with an overlap of more than two elements, to promote chemical diversity. All structures are removed belonging to ‘well explored’ systems from the training data set, in order to assess the capability of the present model to recover existing stable structures without having seen them during training. The ‘partially explored’ class was instead designed to assess the capability of the present model to expand known convex hulls; the existing data belonging to such systems was not, therefore, removed from the training set. Finally, the ‘not explored’ class was designed to test the present model in chemical systems where no structures on the hull are known.

For this task, the present unconditional generative model is fine-tuned on two properties: chemical system and energy above hull, following the encoding procedures shown in Section E.3 and Section E.3, respectively, to form a conditional generative model. Both properties are available for the training set of the unconditional generative model, and therefore it is used in full for fine-tuning. At sampling time, the model was instructed to condition on energy above hull=0.0 eV/atom, and on the chemical system to be sampled.

To compare the performance of the present conditional generative model against substitution and RSS, an expanded version of the M3GNet machine learning force field (ML-FF) was employed to relax the generated structures, and then perform ab initio relaxation and static calculations via DFT (See Section G.7 and Section G.8 for details). For both the present conditional generative model and the two benchmarks, structures were generated, relaxed using the ML-FF, filtered for uniqueness, 100 structures with lowest predicted energy above hull according to the ML-FF were selected, DFT were run on these selected structures, and metrics were reported only with respect to those structures. To allow for a fair comparison between the present generative model and non-generative approaches, the ML-FF relaxation was employed on a greater number of samples for the latter. For RSS, 600,000 structures per chemical system were sampled according to the protocol of described in Section G.5. For substitution, every possible structure was enumerated according to the algorithm detailed in Section G.6, which yields between 15000 and 70000 structures per chemical system. This generated 10240 structures per chemical system for the model.

### F.3 Conditioning on Space Group

For the task of generating structures belonging to a target space group, the present unconditional generative model was fine-tuned on the whole training set to form a conditional generative model, and the space group information was encoded as detailed in Section E.3. The capability of the present conditional generative model to correctly generate structures belonging to any space group via two tasks was assessed. For the first task, 2 space groups were sampled for each of the 7 lattice systems, from space groups that contain at least 0.1% of the training set. Then, the fraction of structures the conditional generative model generates when conditioned on these space groups that are classified as belonging to that space group according to the pymatgen space group analyzer module was computed. This is computed for 256 generated structures per space group, after DFT relaxation has been performed. For the second task, 10000 structures were generated conditioned on space groups sampled randomly from the data distribution of the training set, and whether the present model was able to reproduce such a distribution was checked. For both of the above, whenever a space group is chosen for conditioning, the number of atoms in the systems are sampled from the distribution of number of atoms for that space group in the training set. This way, incurring in ‘impossible’ tasks is avoided, such as where the space group conditioned on cannot be satisfied given the number of atoms set.

### F.4 Conditioning on Single Properties

To generate structures conditioned on a target property, the present unconditional generative model is fine-tuned on magnetic density (N=605000 DFT labels), band gap (N=42000) and bulk modulus (N=5000), respectively. See Section E.2 for more details on the fine-tuning scheme, and Section G.2 for hyperparameter settings. The properties were encoded as described in Section E.3.

For each property in FIGS. 5A-5C, 512 samples are generated with the conditional generative model. Those structures are relaxed using the MLFF and filter the relaxed structures by stability (below 0.1 eV/atom of Alex-MP hull) and uniqueness. Then the remaining structures are relaxed with DFT and filtered by stability, uniqueness, and novelty (with respect to Alex-MP). Finally, the desired property of the remaining structures is computed using DFT. For more details on the DFT calculations, see Section G.8.

For the screening baseline, a separate property predictor is trained for both bulk modulus. More details about the model architecture and training procedure are provided in Section G.3, and training hyperparameters are in Section G.3.

### F.5 Conditioning on Multiple Properties

To generate structures conditioned on magnetic density and HHI score, the present unconditional generative model is fine-tuned on these two properties, encoded as described in Section E.3, to form a conditional generative model. To evaluate the performance of the conditional generative model, as detailed in Section F.4, 512 samples are generated with the conditional generative model, by conditioning on magnetic density=0.2 Å⁻³ and HHI score=1200. Of those, 130 samples remain after filtering by stability and uniqueness following the DFT relaxation. Finally, a total of 112 structures pass the novelty check with respect to reference data set and are reported in FIG. 6A.

### APPENDIX G EXPERIMENTAL DETAILS

### G.1 Hyperparameters for Training Unconditional Models

The base unconditional generative model was trained for 1.74 million steps with a batch size of 64 per GPU over 8 A100 GPUs using Adam optimizer. The learning rate was initialized at 0.0001 and was decayed using ReduceLROnPlateau scheduler with decay factor 0.6, patience 100 and minimum learning rate 10⁻⁶.

### G.2 Hyperparameters for Fine-Tuning Models

For all fine-tuning models, a global batch size of 128 and the Adam optimizer are used. Gradient clipping was applied by value at 0.5. The learning rate was initialized at 6×10⁻⁵ and the same learning rate scheduler was used as that for the unconditional generative model. The training was stopped when the validation loss stopped improving for 100 epochs, which resulted in 32 thousand-1.1 million steps depending on the dataset.

### G.3 Screening Details

The screening baseline used in Section 2.5 requires a bulk modulus property predictor. The model architecture consists of a GemNet-dT encoder that provides atom and edge embeddings, followed by a mean readout layer. Three message passing layers were employed, a cutoff radius of 10 Å for the neighbor list construction was used, and the dimension of nodes and edges hidden representations was set to 128.

### Property Predictor for Bulk Modulus

All materials are used with DFT Voigt-Reuss-Hill average bulk modulus values from Materials Project (including structures with more than 20 atoms), which are 7108 structures in total. 80% of the data is allocated for the training set, 10% for validation, and 10% for testing. The MatBench benchmark is followed and the log 10 bulk modulus is predicted. At the end of training, the model achieves a mean absolute error (MAE) of 9.5 GPa.

### Hyperparameters for Training Property Predictor

The property prediction model described above was trained using the Adam optimizer. Gradient clipping was applied by value at 0.5. The learning rate was initialized at 5×10⁻⁴ and decayed using the ReduceLROnPlateau scheduler with decay factor 0.8, patience 10 and minimum learning rate 10⁻⁸. The training was stopped when the validation loss stopped improving for 150 epochs.

### G.4 MatterGen Sampling Parameters

For both unconditional and conditional generation, the reverse diffusion process is discretized over the continuous time interval [0,1] into T=1000 steps. For each time step, ancestral sampling is used to sample (Xᵢ₋₁, Lᵢ₋₁, Aᵢ₋₁) given (Xᵢ, Lᵢ, Aᵢ) using the score model described in Section D.8. After each predictor step, one corrector step was applied. The Langevin corrector was used for the coordinates Xᵢ the lattice Lᵢ with signal to noise ratio parameters 0.4 and 0.2, respectively.

### G.5 Random Structure Search Details

Two rounds of random structure search (RSS) were performed, each generating 300,000 structures. In each round, 100,000 structures were generated in each of the three distinct intervals of the number of atoms in a unit cell. The intervals were 3-9, 10-15, and 16-20 for the ternary systems, 4-10, 11-15, and 16-20 for the quaternary systems and 5-11, 12-16, and 17-20 for the quinary systems. For the first round, AIRSS package is used to propose structures without structural relaxation using MINSEP=0.7-3 (minimum separation between atoms in Å) and SYMMOPS=2-4 (number of symmetry operations). After the first round of RSS, all proposed structures were relaxed using an MLFF (M3GNet, see Section G.7). These 300,000 MLFF relaxation trajectories were used in the second round of RSS to automatically tune the MINSEP parameter. Again AIRSS package was run without structural relaxation followed by a MLFF relaxation. Finally, the 600,000 MLFF-relaxed structures from both rounds were combined and DFT structural relaxation and static calculation were performed on the 100 unique structures with the lowest predicted energy above hull according to the MLFF.

### G.6 Substitution Details

5,143 ordered crystal structures (2,695 ternary, 1,875 quaternary, and 573 quinary) with less than 100 atoms in a unit cell from the Inorganic Crystal Structure Database were used as prototypes. For each chemical system in Table B1 (FIG. 10), all possible unique substitutions of the prototypes were computed, all structures were relaxed using MLFF (M3GNet, see Section G.7), and the 100 unique structures with the lowest predicted energy above the hull according to the MLFF were selected. Finally, DFT structural relaxation and static calculation were run on the selected structures.

### G.7 Machine Learning Force Field (M3GNet) Details

An MLFF trained on 1.08M crystalline structures sampled from MD trajectories was used under temperatures of 0-2000 K and pressures of 0-1000 GPa for MLFF relaxation. The MLFF employed M3Gnet architecture with three graph convolution layers and had in total 890 thousand parameters. To compute the energy above hull, an energy correction scheme compatible with the Materials Project (i.e., MaterialsProject2020Compatibility from pymatgen) was used.

### G.8 DFT Details

All DFT calculations were performed using Vienna Ab initio Simulation package within the projector augmented wave formalism via atomate2 and custodian. Perdew-Burke-Ernzerhof (PBE) generalized-gradient approximation (GGA) functionals were adopted in all calculations. All parameters of the calculations were chosen to be consistent with the Materials Project database.

### DETAILED DESCRIPTION OF THE DRAWINGS

FIGS. 1A-1B shows inorganic materials design with MatterGen. Referring to FIG. 1A, the diffusion model is trained to recover the stable structure of materials by reversing the corruption process and iteratively denoising an initial structure sampled from a random distribution. A forward corruption process is designed to independently corrupt atom types A, coordinates X, and lattice L to approach a distribution of random periodic structures with a fixed atomic density. An equivariant score network is pre-trained to jointly denoise atom types, coordinates, and lattice with a large dataset of stable material structures. Then, the score network is fine-tuned with a conditional dataset that encodes the condition c with an embedding layer. Referring to FIG. 1B, MatterGen can be fine-tuned to generate materials given a broad range of conditions, including chemical systems, space groups, single property, and multiple properties.

FIGS. 2A-2I show generating stable, diverse inorganic materials. FIGS. 2A-2D show visualization of 4 randomly selected generated crystals, with corresponding chemical formula and space group symbols. FIG. 2E shows distribution of energy above the hull using Materials Project (MP) and Alexandria-Materials Project (Alex-MP) dataset as energy references, respectively. FIG. 2F shows distribution of root mean squared deviation (RMSD) between initial generated structures and density functional theory (DFT) relaxed structures. FIG. 2G shows the percentage of novel and unique structures as a function of number of generated structures. Novelty is defined with respect to Alex-MP. FIG. 2H shows the percentage of stable, novel, unique structures for MatterGen and several baseline models. MatterGen-L is trained with Alex-MP; all other models are trained with MP. FIG. 2I shows RMSD between initial structures and DFT relaxed structure for MatterGen and several baseline models.

FIGS. 3A-3I shows generating materials in target chemical system using a conditional generative model. FIG. 3A shows mean percentage of SUN structures for MatterGen-L and benchmarks on 27 chemical systems, grouped by system type. FIG. 3G shows the data from FIG. 3A, but grouped by number of elements in the system. The black lines in FIGS. 3A and 3B indicate the maximum and the minimum. FIG. 3C shows total number of structures on the combined convex hull found by each method and in the reference dataset, grouped by system type. FIG. 3D shows the data of FIG. 3C, but grouped by number of elements in the system. FIG. 3E shows the convex hull diagram for V—Sr—O, a ternary well-explored system. The dots represent structures on the hull their coordinates represent the element ratio of their composition, and their color indicates by which method they were discovered. FIGS. 3F-3I show the four structures (“f”, “g”, “h”, “i”, respectively) the present method discovered on the V—Sr—O hull depicted in FIG. 3E. Composition and space group are reported.

FIGS. 4A-4H show generating materials with target symmetry using a conditional generative model. FIG. 4A shows the fraction of conditionally generated stable, novel, unique structures that belong to the space group the model (MatterGen-L) was conditioned on (dark bars), and fraction of structures belonging to that space group in the reference data set (light bars), for 14 randomly-chosen space groups spanning the seven lattice types, indicated by the labels at the top of the chart. FIGS. 4B-4H show seven generated SUN structures, one per lattice type, drawn at random. Composition and space group are reported.

FIGS. 5A-5O show generating materials with target magnetic, electronic, and mechanical properties using a conditional generative model. FIGS. 5A-5C show density of property values among 1) generated samples by the present model, and 2) structures in the data set for a magnetic, electronic, and mechanical property, respectively. Generated samples are filtered to only contain SUN structures. The target condition for the present generative model is shown as a black dashed line. Magnetic density values<10⁻³ Å⁻³ in a are excluded from the Data baseline to improve readability. FIGS. 5D-5G show visualizations of randomly selected SUN structures generated by the present model with magnetic density>0.2 Å⁻³, along with their chemical formula and space group. FIGS. 5H-5K show visualizations of randomly selected SUN structures generated by the present model with band gap 3±0.1 eV. FIG. 5L shows a visualization of a randomly selected SUN structure generated by the present model with bulk modulus>400 GPa. FIGS. 5M-5O show the number of stable, unique structures that satisfy target constraints found by different approaches across a range of DFT budgets. All structures found by the present model are novel with respect to the data set, and thus they could not be found by screening.

FIGS. 6A-6F shows designing low supply chain risk magnets. Referring to FIG. 6A, by conditioning on a high magnetic density and low HHI score (cross), SUN generated samples (dark dots) are potential candidates for low supply chain risk permanent magnets. The data distribution is shown in light gray. FIG. 6B shows the occurrence of most frequent elements in stable, novel, unique generated samples for a model conditioned jointly on magnetic density and supply chain risk (dark bars), and for a model conditioned only on magnetic density (light bars). FIGS. 6C-6F show stable, novel, unique generated structures on the Pareto front for the joint property optimization task. Chemical composition and point group are reported for each structure.

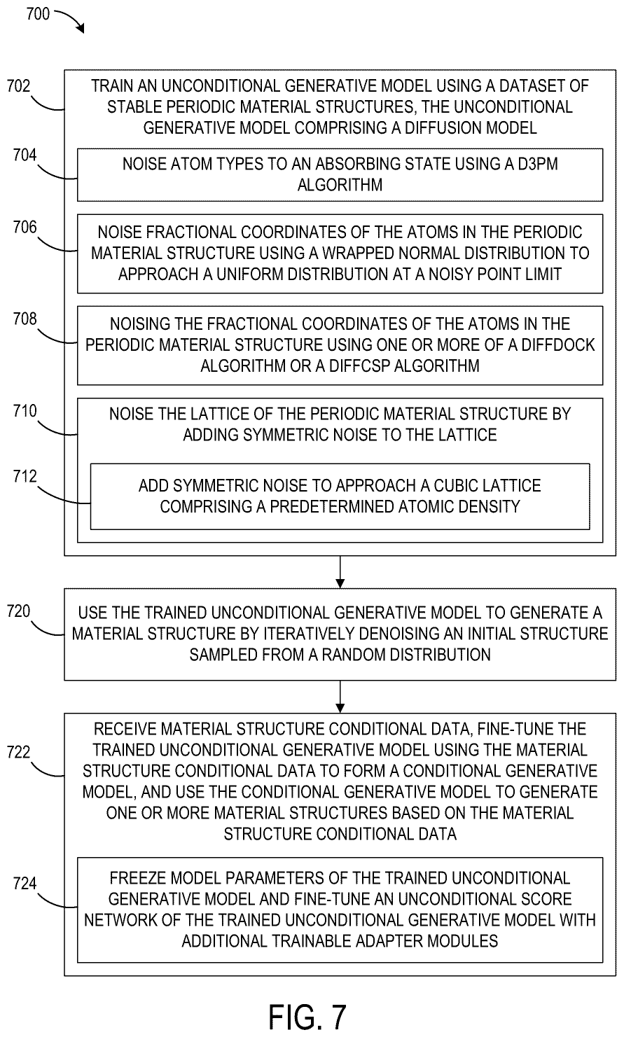

FIG. 7 shows a flow diagram for an example method 700 of generating one or more material structures using MatterGen. At 702, method 700 comprises training an unconditional generative model using a dataset of stable periodic material structures. The unconditional generative model comprises a diffusion model. The training comprising learning the diffusion model to iteratively noise the stable periodic material structures of the dataset towards a random periodic structure by noising atom types of atoms in the periodic material structure, noising fractional coordinates of the atoms in the periodic material structure, and noising a lattice of the periodic material structure.

In some examples, at 704, noising atom types in the periodic material structure comprises noising atom types to an absorbing state using a D3PM algorithm. In some examples, at 706, noising the fractional coordinates of the atoms in the periodic material structure comprises noising fractional coordinates using a wrapped normal distribution to approach a uniform distribution at a noisy point limit. In some examples, at 708, noising the fractional coordinates of the atoms in the periodic material structure comprises noising fractional coordinates using one or more of a DiffDock algorithm or a DiffCSP algorithm. In some examples, at 710, noising the lattice of the periodic material structure comprises adding symmetric noise to the lattice. In some examples, at 712, noising the lattice of the periodic material structure comprises adding symmetric noise to approach a cubic lattice comprising a predetermined atomic density. In other examples, any other suitable noising algorithms can be used.

Continuing, at 720, method 700 further comprises using the trained unconditional generative model to generate a material structure by iteratively denoising an initial structure sampled from a random distribution.

In some examples, at 722, method 700 further comprises receiving material structure conditional data comprising one or more of an atom type condition, a property condition, or a lattice condition, fine-tuning the trained unconditional generative model using the material structure conditional data to form a conditional generative model, and using the conditional generative model to generate one or more material structures based on the material structure conditional data. In some examples, at 724, fine-tuning the trained unconditional generative model comprises freezing model parameters of the trained unconditional generative model and fine-tuning an unconditional score network of the trained unconditional generative model with additional trainable adapter modules.

FIG. 8 shows Table 1 with summary information on the 46 on-hull crystal structures produced by unconditional generation.

FIG. 9 shows distribution of elements in the Materials Project dataset (MP) 900 and distribution of elements in the combined Materials Project-Alexandria dataset (Alex-MP) 902. MatterGen was trained using the MP dataset and MatterGen-L, was trained using the combined Alex-MP dataset.

FIG. 10 shows Table B1 with categorization of the 27 chemical systems used to benchmark model capabilities on chemical system exploration.

FIG. 11 shows Table C2, which includes notes on notation.

FIG. 12 shows two equivalent lattice choices with different lattice vectors l₁, l₂ that lead to the same periodic structure.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 13 schematically shows a non-limiting embodiment of a computing system 1300 that can enact one or more of the methods and processes described above. Computing system 1300 is shown in simplified form. Computing system 1300 may embody the computing system 1 described above and illustrated in FIG. 1A. Computing system may be configured to perform method 700 described above. Components of computing system 1300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 1300 includes a logic processor 1302 volatile memory 1304, and a non-volatile storage device 1306. Computing system 1300 may optionally include a display subsystem 1308, input subsystem 1310, communication subsystem 1312, and/or other components not shown in FIG. 13.

Logic processor 1302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 1302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1306 includes one or more physical devices configured to hold instructions executable by the logic processors to implement the methods and processes described herein. When such methods and processes are implemented, the state of non-volatile storage device 1306 may be transformed—e.g., to hold different data.

Non-volatile storage device 1306 may include physical devices that are removable and/or built in. Non-volatile storage device 1306 may include optical memory, semiconductor memory, and/or magnetic memory, or other mass storage device technology. Non-volatile storage device 1306 may include nonvolatile, dynamic, static, read/write, read-only, sequential-access, location-addressable, file-addressable, and/or content-addressable devices. It will be appreciated that non-volatile storage device 1306 is configured to hold instructions even when power is cut to the non-volatile storage device 1306.

Volatile memory 1304 may include physical devices that include random access memory. Volatile memory 1304 is typically utilized by logic processor 1302 to temporarily store information during processing of software instructions. It will be appreciated that volatile memory 1304 typically does not continue to store instructions when power is cut to the volatile memory 1304.

Aspects of logic processor 1302, volatile memory 1304, and non-volatile storage device 1306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1300 typically implemented in software by a processor to perform a particular function using portions of volatile memory, which function involves transformative processing that specially configures the processor to perform the function. Thus, a module, program, or engine may be instantiated via logic processor 1302 executing instructions held by non-volatile storage device 1306, using portions of volatile memory 1304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1308 may be used to present a visual representation of data held by non-volatile storage device 1306. The visual representation may take the form of a graphical user interface (GUI). As the herein described methods and processes change the data held by the non-volatile storage device, and thus transform the state of the non-volatile storage device, the state of display subsystem 1308 may likewise be transformed to visually represent changes in the underlying data. Display subsystem 1308 may include one or more display devices utilizing virtually any type of technology. Such display devices may be combined with logic processor 1302, volatile memory 1304, and/or non-volatile storage device 1306 in a shared enclosure, or such display devices may be peripheral display devices.

When included, input subsystem 1310 may comprise or interface with one or more user-input devices such as a keyboard, mouse, touch screen, camera, or microphone.

When included, communication subsystem 1312 may be configured to communicatively couple various computing devices described herein with each other, and with other devices. Communication subsystem 1312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 1300 to send and/or receive messages to and/or from other devices via a network such as the Internet.

Another example provides a method, comprising training an unconditional generative model using a dataset of stable periodic material structures, the unconditional generative model comprising a diffusion model. The training comprises learning the diffusion model to iteratively noise the stable periodic material structures of the dataset towards a random periodic structure by noising atom types of atoms in the periodic material structure, noising fractional coordinates of the atoms in the periodic material structure, and noising a lattice of the periodic material structure. The method further comprises using the trained unconditional generative model to generate a material structure by iteratively denoising an initial structure sampled from a random distribution. In some such examples, noising atom types in the periodic material structure comprises noising atom types to an absorbing state using a D3PM algorithm. Alternatively or additionally, in some such examples, noising fractional coordinates of the atoms in the periodic material structure comprises noising fractional coordinates using a wrapped normal distribution to approach a uniform distribution at a noisy point limit. Alternatively or additionally, in some such examples, noising fractional coordinates of the atoms in the periodic material structure comprises noising fractional coordinates using one or more of a DiffDock algorithm or a DiffCSP algorithm. Alternatively or additionally, in some such examples, noising the lattice of the periodic material structure comprises adding symmetric noise to the lattice. Alternatively or additionally, in some such examples, noising the lattice of the periodic material structure comprises adding symmetric noise to approach a cubic lattice comprising a predetermined atomic density. Alternatively or additionally, in some such examples, the method further comprises receiving material structure conditional data comprising one or more of an atom type condition, a property condition, or a lattice condition, fine-tuning the trained unconditional generative model using the material structure conditional data to form a conditional generative model, and using the conditional generative model to generate one or more material structures based on the material structure conditional data. Alternatively or additionally, in some such examples, fine-tuning the trained unconditional generative model comprises freezing model parameters of the trained unconditional generative model and fine-tuning an unconditional score network of the trained unconditional generative model with additional trainable adapter modules.

Another example provides a computing system for conditional generation of material structures, the computing system comprising a logic subsystem, and a storage subsystem comprising instructions executable by the logic subsystem to implement a diffusion model, the instructions further executable to, in an inference phase, receive material structure conditional data comprising one or more of an atom type condition, a property condition, and a lattice condition. The instructions are further executable to fine-tune the diffusion model using the material structure conditional data, and use the fine-tuned diffusion model to generate one or more material structures based on the material structure conditional data. In some such examples, the instructions are further executable to, prior to the inference phase, train the diffusion model by iteratively noising a plurality of stable periodic material structures towards a random periodic structure by noising atom types of atoms in the periodic material structure, noising fractional coordinates of the atoms in the periodic material structure, and noising a lattice of the periodic material structure. Alternatively or additionally, in some such examples, the conditional data comprises an atom type condition, a property condition, and a lattice condition. Alternatively or additionally, in some such examples, the instructions are executable to fine-tune the diffusion model by freezing model parameters of the diffusion model and fine-tuning an unconditional score network of the diffusion model with additional trainable adapter modules.

Another example provides a computing system for generation of material structures. The computing system comprises a logic subsystem, and a storage subsystem comprising instructions executable by the logic subsystem to receive a dataset of stable periodic material structures. The instructions are further executable to, using the dataset, train an unconditional generative model comprising a diffusion model to iteratively noise the stable periodic material structures of the dataset towards a random periodic structure by noising atom types of atoms in the periodic material structure, noising fractional coordinates of the atoms in the periodic material structure, and noising a lattice of the periodic material structure. The instructions are further executable to use the trained unconditional generative model to generate a material structure by iteratively denoising an initial structure sampled from a random distribution. In some such examples, the instructions are further executable to receive material structure conditional data comprising one or more of an atom type condition, a property condition, or a lattice condition, fine-tune the trained unconditional generative model using the material structure conditional data to form a conditional generative model, and using the conditional generative model to generate one or more material structures based on the material structure conditional data. Alternatively or additionally, in some such examples, the instructions are executable to fine-tune the trained unconditional generative model by freezing model parameters of the trained unconditional generative model and fine-tuning an unconditional score network of the trained unconditional generative model with additional trainable adapter modules. Alternatively or additionally, in some such examples, the instructions are executable to noise the atom types in the periodic material structure to an absorbing state using a D3PM algorithm. Alternatively or additionally, in some such examples, the instructions are executable to noise the fractional coordinates of the atoms in the periodic material structure using a wrapped normal distribution to approach a uniform distribution at a noisy point limit. Alternatively or additionally, in some such examples, the instructions are executable to noise the fractional coordinates of the atoms in the periodic material structure using one or more of a DiffDock algorithm or a DiffCSP algorithm. Alternatively or additionally, in some such examples, the instructions are executable to noise the lattice of the periodic material structure by adding symmetric noise to the lattice. Alternatively or additionally, in some such examples, the instructions are executable to noise the lattice of the periodic material structure by adding symmetric noise to approach a cubic lattice comprising a predetermined atomic density.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method, comprising:
training an unconditional generative model using a dataset of stable periodic material structures, the unconditional generative model comprising a diffusion model, the training comprising learning the diffusion model to iteratively noise the stable periodic material structures of the dataset towards a random periodic structure by
noising atom types of atoms in the periodic material structure,
noising fractional coordinates of the atoms in the periodic material structure, and
noising a lattice of the periodic material structure; and
using the trained unconditional generative model to generate a material structure by iteratively denoising an initial structure sampled from a random distribution.

2. The method of claim 1, wherein noising atom types in the periodic material structure comprises noising atom types to an absorbing state using a D3PM algorithm.

3. The method of claim 1, wherein noising fractional coordinates of the atoms in the periodic material structure comprises noising fractional coordinates using a wrapped normal distribution to approach a uniform distribution at a noisy point limit.

4. The method of claim 3, wherein noising fractional coordinates of the atoms in the periodic material structure comprises noising fractional coordinates using one or more of a DiffDock algorithm or a DiffCSP algorithm.

5. The method of claim 1, wherein noising the lattice of the periodic material structure comprises adding symmetric noise to the lattice.

6. The method of claim 5, wherein noising the lattice of the periodic material structure comprises adding symmetric noise to approach a cubic lattice comprising a predetermined atomic density.

7. The method of claim 1, further comprising:
receiving material structure conditional data comprising one or more of an atom type condition, a property condition, or a lattice condition,
fine-tuning the trained unconditional generative model using the material structure conditional data to form a conditional generative model, and
using the conditional generative model to generate one or more material structures based on the material structure conditional data.

8. The method of claim 7, wherein fine-tuning the trained unconditional generative model comprises freezing model parameters of the trained unconditional generative model and fine-tuning an unconditional score network of the trained unconditional generative model with additional trainable adapter modules.

9. A computing system for conditional generation of material structures, the computing system comprising:
a logic subsystem; and
a storage subsystem comprising instructions executable by the logic subsystem to implement a diffusion model, the instructions further executable to
in an inference phase, receive material structure conditional data comprising one or more of an atom type condition, a property condition, and a lattice condition,
fine-tune the diffusion model using the material structure conditional data, and
use the fine-tuned diffusion model to generate one or more material structures based on the material structure conditional data.

10. The computing system of claim 9, wherein the instructions are further executable to, prior to the inference phase, train the diffusion model by iteratively noising a plurality of stable periodic material structures towards a random periodic structure by
noising atom types of atoms in the periodic material structure,
noising fractional coordinates of the atoms in the periodic material structure, and
noising a lattice of the periodic material structure.

11. The computing system of claim 9, wherein the conditional data comprises an atom type condition, a property condition, and a lattice condition.

12. The computing system of claim 9, wherein the instructions are executable to fine-tune the diffusion model by freezing model parameters of the diffusion model and fine-tuning an unconditional score network of the diffusion model with additional trainable adapter modules.

13. A computing system for generation of material structures, the computing system comprising:
a logic subsystem; and
a storage subsystem comprising instructions executable by the logic subsystem to
receive a dataset of stable periodic material structures,
using the dataset, train an unconditional generative model comprising a diffusion model to iteratively noise the stable periodic material structures of the dataset towards a random periodic structure by
noising atom types of atoms in the periodic material structure,
noising fractional coordinates of the atoms in the periodic material structure, and
noising a lattice of the periodic material structure, and
use the trained unconditional generative model to generate a material structure by iteratively denoising an initial structure sampled from a random distribution.

14. The computing system of claim 13, wherein the instructions are further executable to
receive material structure conditional data comprising one or more of an atom type condition, a property condition, or a lattice condition,
fine-tune the trained unconditional generative model using the material structure conditional data to form a conditional generative model, and
using the conditional generative model to generate one or more material structures based on the material structure conditional data.

15. The computing system of claim 14, wherein the instructions are executable to fine-tune the trained unconditional generative model by freezing model parameters of the trained unconditional generative model and fine-tuning an unconditional score network of the trained unconditional generative model with additional trainable adapter modules.

16. The computing system of claim 13, wherein the instructions are executable to noise the atom types in the periodic material structure to an absorbing state using a D3PM algorithm.

17. The computing system of claim 13, wherein the instructions are executable to noise the fractional coordinates of the atoms in the periodic material structure using a wrapped normal distribution to approach a uniform distribution at a noisy point limit.

18. The computing system of claim 13, wherein the instructions are executable to noise the fractional coordinates of the atoms in the periodic material structure using one or more of a DiffDock algorithm or a DiffCSP algorithm.

19. The computing system of claim 13, wherein the instructions are executable to noise the lattice of the periodic material structure by adding symmetric noise to the lattice.

20. The computing system of claim 19, wherein the instructions are executable to noise the lattice of the periodic material structure by adding symmetric noise to approach a cubic lattice comprising a predetermined atomic density.
